(19) United States
(12) Patent Application Publication
(10) Pub. No.: US 2025/0137107 A1
(43) Pub. Date: May 1, 2025

(54) STEEL SHEET

(71) Applicant: NIPPON STEEL CORPORATION, Tokyo (JP)

(72) Inventors: Koyo OHGA, Tokyo (JP); Kengo TAKEDA, Tokyo (JP); Katsuya NAKANO, Tokyo (JP)

(73) Assignee: NIPPON STEEL CORPORATION, Tokyo (JP)

(21) Appl. No.: 18/835,311

(22) PCT Filed: Feb. 1, 2023
(86) PCT No.: PCT/JP2023/003190

§ 371 Date: Aug. 1, 2024

(30) Foreign Application Priority Data
Feb. 4, 2022 (JP) 2022-016071

(51) Int. Cl. C22C 38/38; C22C 38/00; C22C 38/06; C22C 38/34

(52) U.S. Cl. CPC C22C 38/38; C22C 38/001; C22C 38/06; C22C 38/34

(57) ABSTRACT

A steel sheet has a predetermined chemical composition, a microstructure at a t/4 portion ranging from ⅛ to ⅜ of a sheet thickness in a sheet thickness direction from a surface includes, by area ratio, ferrite: less than 10.0% and pearlite: more than 90.0%, a remainder of the microstructure is one or two or more of bainite, martensite, and residual austenite, granular cementites present on block boundaries and granular cementites present on colony boundaries have a maximum diameter of 0.50 μm or less in the microstructure, the number of grains of the granular cementites present on the block boundaries and grains of the granular cementites present on the colony boundaries per unit length is 0.3 pieces/μm or more and 5.0 pieces/μm or less, the granular cementites are cementites having an aspect ratio of less than 10, and a tensile strength is 1,200 MPa or more.

### TECHNICAL FIELD OF THE INVENTION

The present invention relates to a steel sheet.

Priority is claimed on Japanese Patent Application No. 2022-016071, filed on Feb. 4, 2022, the content of which is incorporated herein by reference.

### RELATED ART

The present invention relates to a steel sheet.

These days, as industrial technology fields are highly divided, materials used in each technology field require special and advanced performance. In particular, with regard to steel sheets for a vehicle, in order to reduce the weight of a vehicle body and improve fuel efficiency in consideration of the global environment, there is a significantly increasing demand for high strength steel sheets. However, most metal materials deteriorate in various properties with high-strengthening, and the hydrogen embrittlement susceptibility particularly increases. It is known that the hydrogen embrittlement susceptibility increases when the tensile strength of a steel member is 1,200 MPa or more, and there is a case of hydrogen embrittlement cracking in bolt steel for which high-strengthening has been progressed ahead of the vehicle field. Therefore, for high strength steel sheets having a tensile strength of 1,500 MPa or more, there is a strong demand for a radical solution to hydrogen embrittlement.

Since the intrusion of hydrogen also occurs at room temperature, the intrusion of hydrogen cannot be completely suppressed in steel sheets for a vehicle. Therefore, it is essential to modify the structure of a steel sheet in order to increase the hydrogen embrittlement resistance properties.

In the related art, steel sheets having a microstructure mainly including martensite have been applied as high strength steel sheets for use in vehicle components. However, in recent years, it has also been considered to apply steel sheets having, as their main structures, a pearlite structure that has more excellent hydrogen embrittlement resistance properties (hydrogen embrittlement resistance) than a martensite structure when compared at the same strength.

For example, Patent Document 1 discloses a high strength steel sheet having a tensile strength of 1,500 MPa or more and containing, as a composition, by mass %, C; 0.3% to 1.0%, Si: 2.0% or less, Mn: 2.0% or less, P: 0.005% to 0.1%, S: 0.05% or less, Al: 0.005% to 0.1%, N: 0.01% or less, any one or more of Cr: 0.2% or more and 4.0% or less, Mo: 0.2% or more and 4.0% or less, and Ni: 0.2% or more and 4.0% or less, and a remainder consisting of Fe and unavoidable impurities, in which in a primary phase structure, ferrite and carbides form layers, a carbide has an aspect ratio of 10 or more, a layered structure in which an interval between the layers is 50 nm or less occupies 65% or more of the whole structure by volume percentage, and among the carbides that form layers with ferrite, a fraction of carbides having an aspect ratio of 10 or more and an angle of 25° or less with respect to the rolling direction is 80% or more by area ratio.

Patent Document 2 discloses a high strength steel sheet having a tensile strength of 1,500 MPa or more and containing, as a composition, by mass %, C: 0.3% to 1.0%, Si: 2.5% or less, Mn: 2.5% or less, Si+Mn: 1.0% or more, P: 0.005% to 0.1%, S: 0.05% or less, Al: 0.005% to 0.1%, N: 0.01% or less, and a remainder consisting of Fe and unavoidable impurities, in which in a primary phase structure, ferrite and carbides form layers, a carbide has an aspect ratio of 10 or more, a layered structure in which an interval between the layers is 50 nm or less occupies 65% or more of the whole structure by volume percentage, and among the carbides that form layers with ferrite, a fraction of carbides having an aspect ratio of 10 or more and an angle of 25° or less with respect to the rolling direction is 75% or more by area ratio.

Patent Documents 1 and 2 describe that the high strength steel sheet is excellent in bendability and delayed fracture resistance properties since carbides extended in the rolling direction strengthen in the bending direction like a fiber structure.

### PRIOR ART DOCUMENT

### Patent Document

[Patent Document 1] Japanese Unexamined Patent Application, First Publication No. 2010-138488
[Patent Document 2] Japanese Unexamined Patent Application, First Publication No. 2010-138489

### DISCLOSURE OF THE INVENTION

### Problems to be Solved by the Invention

In cases of the steel sheets disclosed in Patent Documents 1 and 2, in a case where a sample bent into a U-shape (R=10 mm) and tightened with a bolt is immersed in a hydrochloric acid having a pH of 3, no fractures are shown for 48 hours or longer.

However, in recent years, there has been a demand for hydrogen embrittlement resistance properties that can withstand even more stringent evaluations. The present inventors evaluated the hydrogen embrittlement resistance properties of the steel sheets disclosed in Patent Documents 1 and 2 under stricter conditions, and as a result, found that the hydrogen embrittlement resistance properties cannot be said to be sufficient.

Therefore, an object of the present invention is to provide a steel sheet that is a high strength steel sheet having a tensile strength of 1,200 MPa or more and has excellent hydrogen embrittlement resistance properties.

### Means for Solving the Problem

The present inventors examined the hydrogen embrittlement resistance properties of a steel sheet having a microstructure mainly including pearlite. As a result, they obtained the following findings.

Pearlite is known to have substructures called blocks or colonies. In a case where coarse cementite is generated at interfaces between the blocks and/or colonies and working is performed in a state in which the coarse cementite is present, a strain gradient is generated at interfaces between the coarse cementite and the base metal. When hydrogen intrudes in a state in which the strain gradient is generated, the hydrogen is likely to be trapped in the strain field and the amount of hydrogen accumulated increases. When the amount of hydrogen accumulated increases, the formation and growth of voids are promoted, voids are connected, and hydrogen embrittlement cracking occurs.

That is, the present inventors found that, in a steel sheet having a microstructure mainly including pearlite, hydrogen embrittlement is caused due to the presence of coarse cementite, and thus it is important to control the coarse cementite.

The present invention has been made in view of the above-described findings. The gist of the present invention is as follows.

[1] A steel sheet according to an aspect of the present invention containing, as a chemical composition, by mass %: C: 0.150% or more and less than 0.400%; Si: 0.01% to 2.00%; Mn: 0.80% to 2.00%; P: 0.0001% to 0.0200%; S: 0.0001% to 0.0200%; Al: 0.001% to 1.000%; N: 0.0001% to 0.0200%; O: 0.0001% to 0.0200%; Cr: 0.500% to 4.000%; Co: 0% to 0.500%; Ni: 0% to 1.000%; Mo: 0% to 1.0000%; Ti: 0% to 0.500%; B: 0% to 0.010%; Nb: 0% to 0.500%; V: 0% to 0.500%; Cu: 0% to 0.500%; W: 0% to 0.100%; Ta: 0% to 0.100%; Sn: 0% to 0.050%; Sb: 0% to 0.050%; As: 0% to 0.050%; Mg: 0% to 0.0500%; Ca: 0% to 0.050%; Y: 0% to 0,050%; Zr: 0% to 0.050%; La: 0% to 0.050%; Ce: 0% to 0.050%, and a remainder: Fe and impurities, in which a microstructure at a t/4 portion ranging from ⅛ to ⅜ of a sheet thickness in a sheet thickness direction from a surface includes, by area ratio, ferrite: less than 10.0%, and pearlite: more than 90.0%, a remainder of the microstructure is one or two or more of bainite, martensite, and residual austenite, when, in the microstructure, a boundary between a block and an adjacent block included in the pearlite is referred to as a block boundary and a boundary between a colony and an adjacent colony included in the pearlite is referred to as a colony boundary, granular cementites are present on one or both of the block boundaries and the colony boundaries, the granular cementites present on the block boundaries and the granular cementites present on the colony boundaries have a maximum diameter of 0.50 μm or less, the number of grains of the granular cementites present on the block boundaries and grains of the granular cementites present on the colony boundaries per unit length on the block boundaries or the colony boundaries is 0.3 pieces/μm or more and 5.0 pieces/μm or less, and the granular cementites are cementites having an aspect ratio of less than 10, and a tensile strength is 1,200 MPa or more.

[2] In the steel sheet according to [1], the chemical composition may contain, by mass %, one or more selected from the group consisting of Co: 0.001% to 0.500%, Ni: 0.001% to 1.000%, Mo: 0.0005% to 1.0000%, Ti: 0.001% to 0.500%, B: 0.001% to 0.010%, Nb: 0.001% to 0.500%, V: 0.001% to 0.500%, Cu: 0.001% to 0.500%, W: 0.001% to 0.100%, Ta: 0.001% to 0.100%, Sn: 0.001% to 0.050%, Sb: 0.001% to 0.050%, As: 0.001% to 0.050%, Mg: 0.0001% to 0.0500%, Ca: 0.001% to 0.050%, Y: 0.001% to 0.050%, Zr: 0.001% to 0.050%, La: 0.001% to 0.050%, and Ce: 0.001% to 0.050%.

[3] In the steel sheet according to [1] or [2], a coating layer containing zinc, aluminum, magnesium, or an alloy of these metals may be provided on the surface.

### Effects of the Invention

According to the aspect of the present invention, it is possible to provide a high strength steel sheet having excellent hydrogen embrittlement resistance properties.

### BRIEF DESCRIPTION OF THE DRAWINGS

FIG. 1 is a diagram showing the relationship between: a maximum diameter of granular cementites present on block boundaries and colony boundaries and the number of grains of the granular cementites per unit length on the block boundaries and the colony boundaries; and hydrogen embrittlement resistance properties (hydrogen embrittlement resistance).

### EMBODIMENTS OF THE INVENTION

Hereinafter, a steel sheet according to an embodiment of the present invention (the steel sheet according to the present embodiment) will be described.

A steel sheet according to the present embodiment has a predetermined chemical composition, a microstructure at a t/4 portion includes, by area ratio, ferrite: less than 10.0% and pearlite: more than 90.0%, a remainder of the microstructure is one or two or more of bainite, martensite, and residual austenite, when a boundary between a block and an adjacent block included in the pearlite is referred to as a block boundary and a boundary between a colony and an adjacent colony included in the pearlite is referred to as a colony boundary in the microstructure, granular cementites are present on one or both of the block boundaries and the colony boundaries, granular cementites present on the block boundaries and granular cementites present on the colony boundaries have a maximum diameter of 0.50 μm or less, the number of grains of the granular cementites present on the block boundaries and grains of the granular cementites present on the colony boundaries per unit length on the block boundaries or the colony boundaries is 0.3 pieces/μm or more and 5.0 pieces/μm or less, and the granular cementites are cementite having an aspect ratio of less than 10, and a tensile strength is 1,200 MPa or more.

### <Chemical Composition>

First, the content range of each of the elements constituting the chemical composition of the steel sheet according to the present embodiment will be described. Hereinafter, “%” regarding the amount of each element means “mass %”, In addition, ranges shown using “to” include values at both ends thereof as a lower limit and an upper limit.

### C: 0.150% or More and Less Than 0.400%

C is an effective element for increasing the tensile strength at a low cost. In a case where the C content is less than 0.150%, a target tensile strength cannot be obtained, and the fatigue properties of a weld deteriorate. Therefore, the C content is set to 0.150% or more. The C content may be 0.160% or more, 0.180% or more, or 0.200% or more.

Meanwhile, in a case where the C content is 0.400% or more, the cementite on the block boundaries and the colony boundaries may coarsen, and the hydrogen embrittlement resistance properties and the weldability may decrease. Therefore, the C content is set to less than 0.400%. The C content may be 0.350% or less, less than 0.300%, or 0.250% or less.

### Si: 0.01% to 2.00%

Si is an element that acts as a deoxidizing agent and affects the morphology of carbide. In a case where the Si content is less than 0.01%, it is difficult to suppress the formation of coarse oxides. The coarse oxides serve as crack initiation points, and the cracking propagates in the steel material, leading to a deterioration in hydrogen embrittlement resistance properties. Therefore, the Si content is set to 0.01% or more. The Si content may be 0.05% or more, 0.10% or more, or 0.30% or more,

Meanwhile, in a case where the Si content is more than 2.00%, the local ductility may decrease and the hydrogen embrittlement resistance properties may deteriorate. Therefore, the Si content is set to 2.00% or less. The Si content may be 1.80% or less, 1.60% or less, or 1.40% or less.

### Mn: 0.80% to 2.00%

Mn is an effective element for increasing the strength of the steel sheet. In a case where the Mn content is less than 0.80%, the effect cannot be sufficiently obtained. Therefore, the Mn content is set to 0.80% or more. The Mn content may be 1.00% or more or 1.20% or more.

Meanwhile, in a case where the Mn content is more than 2.00%, Mn may not only promote co-segregation with P and S, but also deteriorate the corrosion resistance and the hydrogen embrittlement resistance properties. Therefore, the Mn content is set to 2.00% or less. The Mn content may be 1.90% or less, 1.85% or less, or 1.80% or less.

### P: 0.0001% to 0.0200%

Pis an element that strongly segregates to ferrite grain boundaries and promotes embrittlement of the grain boundaries. In a case where the P content is more than 0.0200%, the hydrogen embrittlement resistance properties significantly decrease due to the embrittlement of the grain boundaries. Therefore, the P content is set to 0.0200% or less. The P content may be 0.0180% or less, 0.0150% or less, or 0.0120% or less.

The P content is preferably as small as possible. However, in a case where the P content is less than 0.0001%, the time required for refining increases and this leads to a significant increase in cost. Therefore, the P content is set to 0.0001% or more. The P content may be 0.0005% or more, 0.0010% or more, or 0.0050% or more.

### S: 0.0001% to 0.0200%

S is an element that forms non-metallic inclusions such as MnS in the steel. In a case where the S content is more than 0.0200%, non-metallic inclusions that serve as crack initiation points in cold working are noticeably formed. In this case, cracking occurs from the non-metallic inclusions, and the cracking propagates in the steel material, leading to a deterioration in hydrogen embrittlement resistance properties. Therefore, the S content is set to 0.0200% or less. The S content may be 0.0180% or less, 0.0150% or less, or 0.0100% or less.

The S content is preferably as small as possible. However, in a case where the S content is less than 0.0001%, the time required for refining increases and this leads to a significant increase in cost. Therefore, the S content is set to 0.0001% or more. The S content may be 0.0005% or more, 0.0010% or more, or 0.0020% or more.

### Al: 0.001% to 1.000%

Al is an element that acts as a deoxidizing agent for steel and stabilizes ferrite. In a case where the Al content is less than 0.001%, the effect cannot be sufficiently obtained. Therefore, the Al content is set to 0.001% or more. The Al content may be 0.005% or more, 0.010% or more, 0.020% or more, or more than 0.100%.

Meanwhile, in a case where the Al content is more than 1.000%, coarse Al oxides are formed. The coarse oxides serve as crack initiation points. Therefore, in a case where coarse Al oxides are formed, cracking occurs from the coarse oxides even in a case where grain boundaries are strengthened, and the cracking propagates in the steel material, leading to a deterioration in hydrogen embrittlement resistance properties. Therefore, the Al content is set to 1.000% or less. The Al content may be 0.950% or less, 0.900% or less, or 0.800% or less. Here, the Al content is a total-Al content.

### N: 0.0001% to 0.0200%

N is an element that forms coarse nitrides in the steel sheet and decreases the hydrogen embrittlement resistance properties of the steel sheet. In addition, Nis an element that causes the generation of blowholes during welding.

In a case where the N content is more than 0.0200%, the hydrogen embrittlement resistance properties deteriorate, and the generation of blowholes is noticeable. Therefore, the N content is set to 0.0200% or less. The N content may be 0.0180% or less, 0.0160% or less, or 0.0120% or less.

Meanwhile, in a case where the N content is set to less than 0.0001%, the manufacturing cost increases significantly. Therefore, the N content is set to 0.0001% or more. The N content may be 0.0005% or more, 0.0010% or more, or 0.0050% or more.

### O: 0.0001% to 0.0200%

O is an element that forms oxides and deteriorates the hydrogen embrittlement resistance properties. In particular, the oxides are present as inclusions in many cases. In a case where the oxides are present in a punched end surface or a cut surface, notch-like scratches or coarse dimples are formed on the end surface, which cause stress concentration during intensive working. These serve as crack initiation points and significantly deteriorate the workability. In a case where the O content is more than 0.0200%, the above-described tendency of deterioration in workability is noticeable. Therefore, the O content is set to 0.0200% or less. The O content may be 0.0150% or less, 0.0100% or less, or 0.0050% or less.

The O content is preferably low. However, from the economic perspective, it is not preferable the O content be less than 0.0001% due to an excessive increase in cost. Therefore, the O content is set to 0.0001% or more. The O content may be 0.0005% or more, 0.0010% or more, or 0.0015% or more.

### Cr: 0.500% to 4.000%

Cr is an effective element for controlling the morphology of a pearlite structure and increasing the strength of the steel sheet by suppressing the growth of a ferrite structure. In a case where the Cr content is less than 0.500%, the effect of suppressing the growth of the ferrite structure may not be sufficiently obtained, and the strength may decrease. Therefore, the Cr content is set to 0.500% or more. The Cr content may be 0.800% or more or 1.000% or more.

Meanwhile, in a case where the Cr content is more than 4.000%, coarse Cr carbides are formed in a center segregation portion and the hydrogen embrittlement resistance properties deteriorate. Therefore, the Cr content is set to 4.000% or less. The Cr content may be 3.500% or less or 3.000% or less.

The base elements of the chemical composition of the steel sheet according to the present embodiment are as described above. That is, the chemical composition of the steel sheet according to the present embodiment may contain the above elements and a remainder of Fe and impurities. Meanwhile, the chemical composition of the steel sheet according to the present embodiment may contain, instead of a part of Fe in the remainder, one or more of Co, Ni, Mo, Ti, B, Nb, V, Cu, W, Ta, Sn, Sb, As, Mg, Ca, Y, Zr, La, and Ce as an optional component in order to improve various properties.

Since these elements do not necessarily need to be contained, the lower limits thereof in content are 0%. In addition, even in a case where these elements are contained as impurities within the following content ranges, the effects of the steel sheet according to the present embodiment are not impaired.

### Co: 0% to 0.500%

Co is an effective element for controlling the morphology of carbide and increasing the strength of the steel sheet. Therefore, Co may be contained. To sufficiently obtain the effects, the Co content is preferably set to 0.001% or more. The Co content may be 0.002% or more, 0.005% or more, or 0.010% or more.

Meanwhile, in a case where the Co content is more than 0.500%, coarse Co carbides are precipitated. In this case, the hydrogen embrittlement resistance properties may deteriorate. Therefore, the Co content is set to 0.500% or less. The Co content may be 0.450% or less, 0.400% or less, or 0.300% or less.

### Ni: 0% to 1.000%

Ni is an effective element for increasing the strength of the steel sheet. In addition, Ni is also an effective element for improving the wettability and promoting an alloying reaction. Therefore, Ni may be contained. In order to obtain the above effect, the Ni content is preferably set to 0.001% or more. The Ni content may be 0.002% or more, 0.005% or more, 0.010% or more, or 0.100% or more.

Meanwhile, in a case where the Ni content is more than 1.000%, the hydrogen embrittlement resistance properties may decrease. Therefore, the Ni content is set to 1.000% or less. The Ni content may be 0.900% or less, 0.800% or less, or 0.600% or less.

### Mo: 0% to 1.0000%

Mo is an effective element for increasing the strength of the steel sheet. In addition, Mo is an element having an effect of suppressing ferritic transformation that occurs during a heat treatment in continuous annealing equipment or continuous hot-dip galvanizing equipment. Therefore, Mo may be contained. In order to obtain the above effect, the Mo content is preferably set to 0.0001% or more. The Mo content may be 0.0002% or more, 0.0005% or more, 0.0008% or more, or 0.1000% or more.

Meanwhile, in a case where the Mo content is more than 1.0000%, the effect of suppressing ferritic transformation is saturated. Therefore, the Mo content is set to 1.0000% or less. The Mo content may be 0.9000% or less, 0.8000% or less, or 0.6000% or less.

### Ti: 0% to 0.500%

Ti is an element that contributes to an increase in strength of the steel sheet by precipitation strengthening, grain refinement strengthening by suppressing the growth of ferrite crystal grains, and dislocation strengthening by suppressing recrystallization. Therefore, Ti may be contained. In order to obtain the above effect, the Ti content is preferably set to 0.001% or more. The Ti content may be 0.005% or more, 0.010% or more, or 0.050% or more.

Meanwhile, in a case where the Ti content is more than 0.500%, the precipitation of carbonitrides may increase and the hydrogen embrittlement resistance properties may deteriorate. Therefore, the Ti content is set to 0.500% or less. The Ti content may be 0.450% or less, 0.400% or less, or 0.300% or less.

### B: 0% to 0.010%

B is an element that suppresses the formation of ferrite and pearlite in the course of cooling from an austenite temperature range and promotes the formation of a low temperature transformation structure such as bainite or martensite. In addition, B is an element useful for high-strengthening of steel. Therefore, B may be contained. In order to obtain the above effect, the B content is preferably set to 0.001% or more. The B content may be 0.0003% or more, 0.005% or more, or 0.010% or more.

Meanwhile, in a case where the B content is more than 0.010%, coarse B oxides are formed in the steel. Since the oxides serve as initiation points where voids are generated in cold working, the hydrogen embrittlement resistance properties may deteriorate due to the formation of coarse B oxides. Therefore, the B content is set to 0.010% or less. The B content may be 0.008% or less, 0.006% or less, or 0.005% or less.

### Nb: 0% to 0.500%

Similar to Ti, Nb is an effective element for controlling the morphology of carbide and is also an effective element for improving the toughness by refining the structure. Therefore, Nb may be contained. In order to obtain the above effect, the Nb content is preferably set to 0.001% or more. The Nb content may be 0.002% or more, 0.005% or more, or 0.010% or more.

Meanwhile, in a case where the Nb content is more than 0.500%, coarse Nb carbides are noticeably formed. Since cracking is likely to occur in the coarse Nb carbides, the hydrogen embrittlement resistance properties may deteriorate due to the formation of the coarse Nb carbides. Therefore, the Nb content is set to 0.500% or less. The Nb content may be 0.450% or less, 0.400% or less, or 0.300% or less.

### V: 0% to 0.500%

Vis an element that contributes to an increase in strength of the steel sheet by precipitation strengthening, grain refinement strengthening by suppressing the growth of ferrite crystal grains, and dislocation strengthening by suppressing recrystallization. Therefore, V may be contained. In order to obtain the above effect, the V content is preferably set to 0.001% or more. The V content may be 0.002% or more, 0.005% or more, or 0.010% or more.

Meanwhile, in a case where the V content is more than 0.500%, the precipitation of carbonitrides may increase and the hydrogen embrittlement resistance properties may deteriorate. Therefore, the V content is set to 0.500% or less. The V content may be 0.450% or less, 0.400% or less, or 0.300% or less.

### Cu: 0% to 0.500%

Cu is an effective element for improving the strength of the steel sheet. In a case where Cu is contained in less than 0.001%, these effects cannot be obtained. Therefore, in order to obtain the above effect, the Cu content is preferably set to 0.001% or more. The Cu content may be 0.002% or more, 0.005% or more, or 0.010% or more.

Meanwhile, in a case where the Cu content is more than 0.500%, the hydrogen embrittlement resistance properties may deteriorate. In addition, in a case where the Cu content is large, the steel material may embrittle during hot rolling and it may not be possible to perform the hot rolling. Therefore, the Cu content is set to 0.500% or less. The Cu content may be 0.450% or less, 0.400% or less, or 0.300% or less.

### W: 0% to 0.100%

W is an effective element for increasing the strength of the steel sheet. In addition, W forms precipitates or crystallized substances. Since the precipitates and crystallized substances containing W act as hydrogen trap sites, W is an effective element for improving the hydrogen embrittlement resistance properties. Therefore, W may be contained. In order to obtain the above effect, the W content is preferably set to 0.001% or more. The W content may be 0.002% or more, 0.005% or more, or 0.010% or more.

Meanwhile, in a case where the W content is more than 0.100%, coarse W precipitates or crystallized substances are noticeably formed. Cracking is likely to occur in the coarse W precipitates or crystallized substances, and the cracking propagates in the steel material with a low load stress. Therefore, in a case where coarse W precipitates or crystallized substances are formed, the hydrogen embrittlement resistance properties may deteriorate. Therefore, the W content is set to 0.100% or less. The W content may be 0.080% or less, 0.060% or less, or 0,050% or less.

### Ta: 0% to 0.100%

Similar to Nb, V, and W, Ta is an effective element for controlling the morphology of carbide and increasing the strength of the steel sheet. Therefore, Ta may be contained. In order to obtain the above effect, the Ta content is preferably set to 0.001% or more. The Ta content may be 0.002% or more, 0.005% or more, or 0.010% or more:

Meanwhile, in a case where the Ta content is more than 0.100%, a large number of fine Ta carbides may be precipitated and the strength of the steel sheet may increase. With this, the ductility may decrease or the bending resistance and the hydrogen embrittlement resistance properties may decrease. Therefore, the Ta content is set to 0.100% or less. The Ta content may be 0.080% or less, 0.060% or less, or 0.050% or less.

### Sn: 0% to 0.050%

Sn is an element that suppresses the coarsening of crystal grains and contributes to the improvement in strength of the steel sheet. Therefore, Sn may be contained. In order to obtain the above effect, the Sn content may be set to 0.001% or more. The Sn content may be 0.002% or more, 0.005% or more, or 0.010% or more.

Meanwhile, in a case where the Sn content is large, the hydrogen embrittlement resistance properties may decrease due to embrittlement of the grain boundaries. The adverse effect is particularly noticeable in a case where the Sn content is more than 0.050%. Therefore, the Sn content is set to 0.050% or less. The Sn content may be 0.040% or less, 0.030% or less, or 0.020% or less.

### Sb: 0% to 0.050%

Sb is an element that contributes to the fine dispersion of inclusions in steel, and is an element that contributes to the improvement in formability of the steel sheet by the fine dispersion. Therefore, Sb may be contained. In order to obtain the above effect, the Sb content may be set to 0.001% or more. The Sb content may be 0.002% or more, 0.005% or more, or 0.010% or more.

Meanwhile, Sb is also an element that strongly segregates to grain boundaries and causes embrittlement of the grain boundaries and a decrease in ductility. The adverse effect is particularly noticeable in a case where the Sb content is more than 0.050%. Therefore, the Sb content is set to 0.050% or less. The Sb content may be 0.040% or less, 0.030% or less, or 0.020% or less.

### As: 0% to 0.050%

As is an element that improves the hardenability and contribute to the high-strengthening of the steel sheet. Therefore, As may be contained. In order to obtain the above effect, the As content may be set to 0.001% or more. The As content may be 0.002% or more, 0.005% or more, or 0.010% or more.

Meanwhile, As is an element that strongly segregates to grain boundaries and causes embrittlement of the grain boundaries and a decrease in ductility. In a case where the As content is large, the hydrogen embrittlement resistance properties may decrease. The adverse effect is particularly noticeable in a case where the As content is more than 0.050%. Therefore, the As content is set to 0.050% or less. The As content may be 0.040% or less, 0.030% or less, or 0.020% or less.

### Mg: 0% to 0.050%

Mg is an element capable of controlling the morphology of sulfide when contained in a small amount. Therefore, Mg may be contained. In order to obtain the above effect, the Mg content is preferably set to 0.001% or more. The Mg content may be 0.005% or more, 0.010% or more, or 0.020% or more.

Meanwhile, in a case where the Mg content is more than 0.050%, coarse inclusions may be formed and the hydrogen embrittlement resistance properties may decrease. Therefore, the Mg content is set to 0.050% or less. The Mg content may be 0.040% or less, 0.030% or less, or 0.020% or less.

### Ca: 0% to 0.050%

Ca is an element that is useful as a deoxidizing element and is also effective in controlling the morphology of sulfide. Therefore, Ca may be contained. In order to obtain the above effect, the Ca content is preferably set to 0.001% or more. The Ca content may be 0.002% or more, 0.005% or more, or 0.010% or more.

Meanwhile, in a case where the Ca content is more than 0.050%, coarse inclusions may be formed and the hydrogen embrittlement resistance properties may decrease. Therefore, the Ca content is set to 0.050% or less. The Ca content may be 0.040% or less, 0.030% or less, or 0.020% or less.

### Y: 0% to 0.050%

Similar to Mg and Ca, Y is an element capable of controlling the morphology of sulfide when contained in a small amount. Therefore, Y may be contained. In order to obtain the above effect, the Y content is preferably set to 0.001% or more. The Y content may be 0.002% or more, 0.005% or more, or 0.010% or more.

Meanwhile, in a case where the Y content is more than 0.050%, coarse Y oxides may be formed and the hydrogen embrittlement resistance properties may decrease. Therefore, the Y content is set to 0.050% or less. The Y content may be 0.040% or less, 0.030% or less, or 0.020% or less.

### Zr: 0% to 0.050%

Similar to Mg, Ca, and Y, Zr is an element capable of controlling the morphology of sulfide when contained in a small amount. Therefore, Zr may be contained. In order to obtain the above effect, the Zr content is preferably set to 0.001% or more. The Zr content may be 0.002% or more, 0.005% or more, or 0.010% or more.

Meanwhile, in a case where the Zr content is more than 0.050%, coarse Zr oxides may be formed and the hydrogen embrittlement resistance properties may decrease. Therefore, the Zr content is set to 0.050% or less. The Zr content may be 0.040% or less, 0.030% or less, or 0.020% or less.

### La: 0% to 0.050%

Similar to Mg, Ca, Y, and Zr, La is an element capable of controlling the morphology of sulfide when contained in a small amount. Therefore, La may be contained. In order to obtain the above effect, the La content is preferably set to 0.001% or more. The La content may be 0.002% or more, 0.005% or more, or 0.010% or more.

Meanwhile, in a case where the La content is more than 0.050%, La oxides may be formed and the hydrogen embrittlement resistance properties may decrease. Therefore, the La content is set to 0.050% or less. The La content may be 0.040% or less, 0.030% or less, or 0.020% or less.

### Ce: 0% to 0.050%

Similar to La, Ce is an element capable of controlling the morphology of sulfide when contained in a small amount. Therefore, Ce may be contained. In order to obtain the above effect, the Ce content is preferably set to 0.001% or more. The Ce content may be 0.002% or more, 0.005% or more, or 0.010% or more.

Meanwhile, in a case where the Ce content is more than 0.050%, Ce oxides may be formed and the hydrogen embrittlement resistance properties may decrease. Therefore, the Ce content is set to 0.050% or less. The Ce content may be 0.040% or less, 0.030% or less, or 0.020% or less.

As described above, the chemical composition of the steel sheet according to the present embodiment may contain base elements and a remainder of Fe and impurities, or may contain base elements, one or more optional elements, and a remainder of Fe and impurities.

The chemical composition of the steel sheet according to the present embodiment may be measured by a general method. For example, the chemical composition may be measured using inductively coupled plasma-atomic emission spectrometry (ICP-AES) for chips according to JIS G 1201:2014. In this case, the chemical composition is an average content throughout the whole sheet thickness. C and S, that cannot be measured by ICP-AES, may be measured using a combustion-infrared absorption method, N may be measured using an inert gas fusion-thermal conductivity method, and O may be measured using an inert gas fusion-nondispersive infrared absorption method.

In a case where the steel sheet is provided with a coating layer on the surface, the chemical composition may be analyzed after removing the coating layer by mechanical grinding or the like. In a case where the coating layer is a plating layer, the coating layer may be removed by dissolving the plating layer in an acid solution to which an inhibitor suppressing the corrosion of the steel sheet is added.

### <Microstructure (Metallographic Structure)>

Next, the microstructure of the steel sheet according to the present embodiment will be described. In the present embodiment, the microstructure is a microstructure at a position ranging from ⅛ to ⅜ (t/4 portion) of the sheet thickness in the sheet thickness direction from the surface of the steel sheet. The reason why the microstructure is regulated in the t/4 portion is that it is a representative microstructure of the steel sheet and has a high correlation with the properties of the steel sheet.

In addition, the fraction (%) of each of the following phases is an area ratio unless otherwise specified.

### [Ferrite: Less Than 10.0%]

Ferrite is a soft structure, and in a case where the area ratio of ferrite is large, a sufficient strength cannot be obtained. In addition, in a case where the area ratio of ferrite is large, the hydrogen embrittlement resistance properties may decrease due to fractures in elastic deformation under stress loading. Therefore, the area ratio of ferrite is set to less than 10.0%. The area ratio of ferrite may be 8.0% or less, 6.0% or less, or 5.0% or less.

The area ratio of ferrite may be 0%. However, in order to control the area ratio to less than 1.0%, a high degree of control is required in the manufacturing, and this leads to a decrease in yield. Therefore, the area ratio of ferrite may be set to 1.0% or more.

### [Pearlite: More Than 90.0%]

Pearlite is an effective structure for obtaining a high strength and excellent hydrogen embrittlement resistance properties. In a case where the area ratio of pearlite is 90.0% or less, it is not possible to obtain a high strength and excellent hydrogen embrittlement resistance properties at the same time. Therefore, the total area ratio of pearlite (including so-called pseudo-pearlite) is set to more than 90.0%.

### [Remainder: One or Two or More of Bainite, Martensite, and Residual Austenite]

In the microstructure, structures other than ferrite and pearlite may not be included (may be 0%), but one or two or more of bainite, martensite, and residual austenite may be included as the remainder. Since the area ratio of pearlite is more than 90.0%, the area ratio of the remainder is less than 10.0% at most.

In the present embodiment, cementite is not included in the calculation of the area ratio (however, cementite in the pearlite lamellar and cementite present on block boundaries and colony boundaries of the pearlite are included in the area ratio as a part of the pearlite).

The area ratios of ferrite, pearlite, bainite, and martensite are obtained by the following method.

The area ratios are obtained by observing a t/4 portion (ranging from ⅛ to ⅜ of the sheet thickness in the sheet thickness direction from the surface of the steel sheet, that is, ranging from ⅛ of the sheet thickness from the surface to ⅜ of the sheet thickness from the surface in which a ¼ position of the sheet thickness is centered in the sheet thickness direction from the surface) of an electron channeling contrast image obtained using a field emission-scanning electron microscope (FE-SEM). The area ratios of ferrite, pearlite, bainite, and martensite are calculated in each of 8 visual fields in a 35 μm×25 μm electron channeling contrast image by an image analysis method, and the average value of the calculated values is defined as the area ratio of each structure.

In that case, each structure is determined according to the following features.

### (Ferrite)

The electron channeling contrast image relates to a method of detecting a crystal orientation difference in crystal grains as a difference in contrast in an image, and in the image, a part that appears with uniform contrast rather than pearlite, bainite, martensite, or residual austenite is determined to be ferrite.

### (Pearlite)

Pearlite is a structure in which plate- or dotted line-like carbides and ferrite are arranged in layers. Since pearlite presents a lamellar structure in which ferrite and cementite are layered, the lamellar region is determined to be pearlite. In the present embodiment, a case where layered cementite is cut in the middle (so-called pseudo-pearlite) is also determined to be pearlite.

### (Bainite)

An aggregate of lath-shaped crystal grains containing no iron-based carbide having a major axis of 20 nm or more, or containing an iron-based carbide having a major axis of 20 nm or more, in which the carbide belongs to a single variant, that is, an iron-based carbide group elongated in the same direction, is determined as bainite. Here, the iron-based carbide group elongated in the same direction means a group in which a difference in elongation direction of the iron-based carbide group is within 5°.

### (Martensite)

Martensite is more difficult to be etched than pearlite, bainite, and ferrite and is thus present as a protrusion on the structure observation section. Martensite includes fresh martensite and tempered martensite. Among them, tempered martensite is an aggregate of lath-shaped crystal grains containing an iron-based carbide having a major axis of 20 nm or more, in which the carbide belongs to a plurality of variants, that is, a plurality of iron-based carbide groups elongated in different directions.

However, since residual austenite is also present as a protrusion on the structure observation section, by subtracting the area ratio of residual austenite measured by the procedure to be described later from the area ratio of the protrusions obtained by the above procedure, the total area ratio of martensite can be accurately measured. In a case where it is not necessary to separately obtain the area ratios of the residual austenite and the martensite, this procedure may not be performed.

### (Method of Evaluating Area Ratio of Residual Austenite)

The area ratio of residual austenite can be calculated by measurement using X-rays (X-ray diffraction). That is, a portion from the sheet surface of a sample to a ¼ position of the sheet thickness in the sheet thickness direction is removed by mechanical polishing and chemical polishing. The polished sample is irradiated with MoKα rays as characteristic X-rays. From the integrated intensity ratio of the diffraction peaks of (200) and (211) of a bcc phase and (200), (220), and (311) of an fcc phase obtained as a result of the operation, the microstructural fraction of residual austenite is calculated, and this is determined to be the area ratio of residual austenite.

### [Granular Cementites are Present on One or Both of Block Boundaries and Colony Boundaries]

### [Maximum Diameter of Granular Cementites Present on Block Boundaries and Colony Boundaries: 0.50 μm or Less]

[Number of Grains of Granular Cementites Present on Block Boundaries and Grains of Granular Cementites Present on Colony Boundaries Per Unit Length on Block Boundaries or Colony Boundaries: 0.3 Pieces/μm or More and 5.0 Pieces/μm or Less]

Pearlite has substructures called blocks or colonies. In the present embodiment, a boundary between a block and an adjacent block is referred to as a block boundary, and a boundary between a colony and an adjacent colony is referred to as a colony boundary.

As described above, pearlite contributes to the improvement in hydrogen embrittlement resistance properties. However, in normal pearlite, coarse cementite may be formed at the interfaces (block boundaries and/or colony boundaries) of blocks and/or colonies. In a case where working is performed in a state in which the coarse cementite is present, a larger strain gradient is generated at interfaces between the coarse cementite and the base metal than at interfaces between the lamellar cementite and base metal. In this state, in a case where hydrogen intrudes, the hydrogen is likely to be trapped in such a strain field. When the hydrogen is trapped and the amount of the hydrogen accumulated increases, the formation and growth of voids are promoted. As a result, voids are connected and hydrogen embrittlement cracking occurs.

Therefore, in the steel sheet according to the present embodiment, on the premise that granular cementites are present on one or both of the block boundaries and the colony boundaries, the size and number density of grains of the granular cementites are controlled. In the present embodiment, the granular cementites are cementites having an aspect ratio of less than 10.

Specifically, in the steel sheet according to the present embodiment, the maximum diameter (maximum circle-equivalent diameter) of the granular cementites present (observed) on the block boundaries and the colony boundaries is set to 0.50 μm or less. In a case where the maximum diameter of the granular cementites is more than 0.50 μm, a large strain gradient is generated at interfaces between the coarse cementites and the base metal and the hydrogen embrittlement resistance properties decrease.

In addition, in the steel sheet according to the present embodiment, the number of grains of the granular cementites present on the block boundaries and grains of the granular cementites present on the colony boundaries per unit length on the block boundaries and the colony boundaries (the number of grains of the granular cementites present on the colony boundaries and the block boundaries per unit length on the colony boundaries and the block boundaries (the number of grains of the granular cementites per unit length on the block boundaries and the colony boundaries, obtained by dividing the total number of grains of the granular cementites present on the block boundaries and grains of the granular cementites present on the colony boundaries by the total length of the block boundaries and the colony boundaries)) is set to 0.3 pieces/μm or more and 5.0 pieces/μm or less. Hereinafter, “the number of grains of the granular cementites present on the block boundaries and grains of the granular cementites present on the colony boundaries per unit length on the block boundaries and the colony boundaries” will also be referred to as the “number density on the boundaries”.

In addition, in a case where the number of grains of the granular cementites present per 1 μm length on the block boundaries and the colony boundaries is less than 0.3 (less than 0.3 pieces/μm), the cementites on the colony boundaries and the block boundaries undergoes stress concentration and a strain gradient is likely to be formed between the base metal and the cementites, so that the hydrogen embrittlement resistance properties deteriorate. Meanwhile, in a case where the number is more than 5.0 (more than 5.0 pieces/μm), the amount of the hydrogen accumulating in the cementites on the colony boundaries and the block boundaries increases, and thus the hydrogen embrittlement resistance properties deteriorate.

The maximum diameter of the granular cementites present on the block boundaries and the colony boundaries is obtained by the following method.

For the maximum diameter of the granular cementites, first, a sample is collected from the steel sheet. A cross section parallel to the sheet thickness direction is polished, and then etched using a Nital aqueous solution (preferably a 3 vol % nitric acid-ethanol aqueous solution). The maximum diameter is obtained by observing a t/4 portion (ranging from ⅛ of the sheet thickness from the surface to ⅜ of the sheet thickness from the surface in which a ¼ position of the sheet thickness is centered in the sheet thickness direction from the surface) of the etched cross section in an electron channeling contrast image obtained using a field emission-scanning electron microscope (FE-SEM). In the electron channeling contrast image, the cementite is observed as a white contrast. 10 visual fields of a 10 μm×10 μm region including block boundaries and colony boundaries (recesses to be described later) are acquired, and the area of granular cementites observed on the block boundaries and the colony boundaries in the visual field (at least a part thereof is observed to be on the boundaries) is measured by image analysis. A circle equivalent diameter is obtained from the above area, and the maximum circle equivalent diameter among the obtained circle equivalent diameters is defined as the maximum diameter of the granular cementites.

Since the block boundaries and the colony boundaries are preferentially corroded by etching and observed as linear recesses in the SEM observation, they can be determined.

The number (the number density on the boundaries) of grains of the granular cementites per unit length on the block boundaries and the colony boundaries is obtained by the following method.

The number (the number density on the boundaries) of grains of the granular cementites per unit length on the block boundaries and the colony boundaries is obtained by observing, similarly to the measurement of the maximum diameter of the granular cementites, a t/4 portion (ranging from ⅛ of the sheet thickness from the surface to ⅜ of the sheet thickness from the surface in which a ¼ position of the sheet thickness is centered in the sheet thickness direction from the surface) of the polished and etched cross section in an electron channeling contrast image obtained using a field emission-scanning electron microscope (FE-SEM). 10 visual fields of a 30 μm×30 μm region including block boundaries and colony boundaries in the electron channeling contrast image are acquired, and the lengths of the block boundaries and the colony boundaries in the visual field are measured by image analysis. After that, the number of grains of the granular cementites present (observed) on the boundaries is counted to obtain the number of grains of the granular cementites per unit length on the block boundaries or the colony boundaries. Specifically, the calculation can be performed with the following formula.

[Number Density on Boundaries]=([Number of Grains of Granular Cementites on Block Boundaries as Measurement Target]+[Number of Grains of Granular Cementites on Colony Boundaries as Measurement Target])/([Length of Block Boundaries as Measurement Target]+[Length of Colony Boundaries as Measurement Target])

In addition, the aspect ratio of the cementite can be obtained by the following method.

The aspect ratio is obtained by observing a t/4 portion (ranging from ⅛ of the sheet thickness from the surface to ⅜ of the sheet thickness from the surface in which a ¼ position of the sheet thickness is centered in the sheet thickness direction from the surface) in an electron channeling contrast image obtained using a field emission-scanning electron microscope (FE-SEM). In the electron channeling contrast image, the cementite is observed as a white contrast. 10 visual fields of a 10 μm×10 μm region including block boundaries and colony boundaries are acquired, and the lengths of a long side and a short side of the cementite present on the block boundaries and the colony boundaries in the visual field are measured by image analysis. The value obtained by dividing the length of the long side by the length of the short side is the aspect ratio of the cementite.

### <Mechanical Properties>

In the steel sheet according to the present embodiment, as a strength that contributes to the weight reduction of vehicles' bodies, a tensile strength (TS) is set to 1,200 MPa or more.

There is no need to limit the upper limit of the tensile strength. However, an increase in tensile strength may cause a decrease in formability. Therefore, the tensile strength may be set to 2,000 MPa or less.

### (Sheet Thickness)

The sheet thickness of the steel sheet according to the present embodiment is not limited, but is preferably 1.0 to 2.2 mm. The sheet thickness is more preferably 1.05 mm or more, and even more preferably 1.1 mm or more. In addition, the sheet thickness is more preferably 2.1 mm or less, and even more preferably 2.0 mm or less.

### <Coating Layer>

The steel sheet according to the present embodiment may have a coating layer containing zinc, aluminum, magnesium, or an alloy of these metals on its one or both surfaces. The coating layer may be made of zinc, aluminum, magnesium or an alloy of these metals and impurities.

Corrosion resistance is improved by providing a coating layer on the surface. In a case where there is a concern about holes due to corrosion in a steel sheet for a vehicle, the steel sheet cannot be thinned to a certain sheet thickness or less in some cases even in a case where the high-strengthening is achieved. One purpose of high-strengthening of the steel sheet is to reduce the weight by making the steel sheet thinner. Accordingly, even in a case where a high strength steel sheet is developed, the member where the steel sheet is to be applied is limited in a case where the steel sheet has low corrosion resistance. As a method for solving these problems, it is considered to form a coating layer on the front and back surfaces in order to improve the corrosion resistance.

Even in a case where a coating layer is formed, the hydrogen embrittlement resistance properties of the steel sheet according to the present embodiment are not impaired.

The coating layer is, for example, a hot-dip galvanized layer, a hot-dip galvannealed layer, an electrogalvanized layer, an aluminum plating layer, a Zn—Al alloy plating layer, an Al—Mg alloy plating layer, or a Zn—Al—Mg alloy plating layer.

In a case where the surface has a coating layer (in a case where the steel sheet according to the present embodiment has a base steel sheet and a coating layer formed on a surface of the base steel sheet), the surface that is a reference for the above-described t/4 portion is the surface of the base metal (base steel sheet) excluding the coating layer.

### <Manufacturing Method>

The steel sheet according to the present embodiment achieves its effects regardless of the manufacturing method as long as the steel sheet has the above features; and the steel sheet can be manufactured by a manufacturing method including the following steps (I) to (VI):
(I) a heating step of heating a steel piece having a predetermined chemical composition;
(II) a hot rolling step of hot-rolling the heated steel piece to obtain a hot-rolled steel sheet;
(III) a cooling step in which cooling of the hot-rolled steel sheet is started within 1.0 second from the completion of the hot rolling step, and the steel sheet is cooled to a coiling temperature of 400° C. or higher and lower than 600° C. at an average cooling rate of 4.0° C./sec or higher and lower than 20.0° C./sec;
(IV) a coiling step of coiling the hot-rolled steel sheet after the cooling step at the coiling temperature;
(V) a cold rolling step of pickling and cold-rolling the hot-rolled steel sheet after the coiling step to obtain a cold-rolled steel sheet; and
(VI) an annealing step of retaining and annealing the cold-rolled steel sheet after the cold rolling step at an annealing temperature of 830° C. or higher and lower than 900° C. for 25 to 100 seconds.

Hereinafter, preferable conditions in each step will be described.

### (Heating Step)

In the heating step, a steel piece such as a slab having the same chemical composition as the steel sheet according to the present embodiment is heated prior to hot rolling.

The heating temperature is not limited as long as the rolling temperature for the next step can be secured. For example, the heating temperature is 1,000° C. to 1,300° C.

The steel piece to be used is preferably cast by a continuous casting method from the viewpoint of productivity, but may be manufactured by an ingot-making method or a thin slab casting method.

In a case where a steel piece obtained by continuous casting can be subjected to the hot rolling step while it maintains a sufficiently high temperature, the heating step may be omitted.

### (Hot Rolling Step)

In the hot rolling step, the heated steel piece is hot-rolled to obtain a hot-rolled steel sheet.

The hot rolling step includes rough rolling and finish rolling. In the finish rolling, a plurality of passes of reduction is performed, and among the plurality of passes, 4 or more passes are large reduction passes with a rolling reduction of 20% or higher. The interpass time between the large reduction passes is set to 5.0 seconds or shorter. Further, the rolling start temperature is set to 950° C. to 1,100° C., and the rolling finishing temperature is set to 800° C. to 950° C.

In this step, structure refinement is mainly conducted. Since the grain boundaries act as the nuclei of transformation, the structure refinement at this stage also results in the structure refinement to be achieved through the transition to the next step.

[Large Reduction Passes with Rolling Reduction of 20% or Higher in Finish Rolling: 4 or More Passes]

### [Interpass Time: Within 5.0 Seconds]

The morphology of austenite grains can be controlled equiaxially and finely by controlling the rolling reduction in finish rolling, the number of times of rolling, and the interpass time. In a case where the austenite grains become equiaxed and fine, grain boundary diffusion of the alloying elements is promoted and precipitation of alloy carbides or nitrides at the grain boundaries is promoted. In a case where the number of passes (large reduction passes) with a rolling reduction of 20% or higher is less than 4, unrecrystallized austenite remains, and it is not possible to sufficiently obtain the effect. Therefore, the rolling reduction is set to 20% or higher in 4 or more passes (4 or more passes of reduction are performed with a rolling reduction of 20% or higher). Preferably, the rolling reduction is set to 20% or higher in 5 or more passes. Meanwhile, the upper limit of the number of passes with a rolling reduction of 20% or higher is not particularly limited. However, in order to conduct more than 10 passes, it is necessary to install a large number of rolling stands, and the size of equipment and the manufacturing cost may be increased. Therefore, the number of passes (number of large reduction passes) with a rolling reduction of 20% or higher may be 10 or less, 9 or less, or 7 or less.

In addition, the interpass time between large reduction passes in finish rolling has a great influence on the recrystallization and grain growth of the austenite grains after rolling. Even in a case where the number of large reduction passes is 4 or more, the grains are likely to grow in a case where each interpass time between the large reduction passes is longer than 5.0 seconds, so the austenite grains become coarse. Each interpass time between the large reduction passes is set to 5.0 seconds or shorter.

Meanwhile, it is not necessary to limit the lower limit of the interpass time. However, in a case where each interpass time between the large reduction passes is shorter than 0.2 seconds, the recrystallization of the austenite is not completed and the proportion of unrecrystallized austenite increases. Therefore, it may not be possible to sufficiently obtain the effect in some cases. Therefore, the interpass time between the large reduction passes is preferably set to 0.2 seconds or longer. The interpass time may be 0.3 seconds or longer or 0.5 seconds or longer. The time between individual passes is preferably set to 0.5 seconds or shorter, regardless of passes with a rolling reduction of lower than 20% or passes (large reduction passes) with a rolling reduction of 20% or higher.

### [Rolling Start Temperature: 950° C. to 1,100° C.]

### [Rolling Finishing Temperature: 800° C. to 950° C.]

In a case where the rolling start temperature and the rolling finishing temperature (finish temperature) are too high, there is a concern that the crystal grains may coarsen.

Meanwhile, in a case where the rolling finishing temperature is low, the rolling force is excessively increased, and thus the steel sheet may not be rolled with a sufficient rolling reduction. In addition, in a case where the rolling start temperature is low, a predetermined rolling finishing temperature may not be secured.

### (Cooling Step)

### (Coiling Step)

In the cooling step and the coiling step, cooling is started within 1.0 second from the completion of the hot rolling step (after the termination of finish rolling), and the steel sheet is cooled to a coiling temperature of 400° C. or higher and lower than 600° C. at an average cooling rate of 4.0° C./sec or higher and lower than 20.0° C./sec and coiled at the coiling temperature.

In these steps, while the formation of ferrite is suppressed to some extent, pearlite and cementite are formed, and cementite is grown to a certain size.

The cementite formed at these steps acts as the nuclei of y-transformation in the subsequent annealing step, and contributes to the structure refinement after annealing. In a case where the formation of ferrite is excessive, cementite is likely to coarsen. The coarse cementite remains undissolved during annealing to be performed later, which may cause a decrease in strength and a deterioration in hydrogen embrittlement resistance properties. Meanwhile, in a case where the cementite is fine, it dissolves at an early stage during annealing and does not act as the nuclei of y-transformation. Therefore, the cementite is grown to a certain size.

In a case where the average cooling rate is lower than 4.0° C./sec during cooling, ferrite is excessively formed, and as a result, the cementite may excessively coarsen. Meanwhile, in a case where the average cooling rate is 20.0° C./sec or higher, a low temperature transformation structure is likely to be formed, and it becomes difficult to perform cold rolling. In this case, there is a concern that a sufficient amount of pearlite may not be formed or cementite may not be sufficiently grown.

In addition, in a case where the time from the termination of finish rolling to the start of cooling is longer than 1.0 second, ferrite grows excessively during that time, and as a result, cementite may coarsen.

In addition, in a case where the coiling temperature (cooling stop temperature) is lower than 400° C., a low temperature transformation structure is generated, the strength increases, and thus it becomes difficult to perform cold rolling.

Meanwhile, in a case where the coiling temperature is higher than 600° C., internal oxidation of the surface proceeds excessively, and it becomes difficult to perform pickling to be performed thereafter. In addition, carbides excessively grow. In this case, there is a concern that the carbides may be non-solid-solubilized during the course of heating in the annealing step to be performed later, austenitizing at the annealing temperature may not be sufficient, and thus the area ratio of pearlite of the steel sheet to be obtained after annealing may decrease.

### (Cold Rolling Step)

In the cold rolling step, the hot-rolled steel sheet after the coiling step is recoiled, pickled, and cold-rolled to obtain a cold-rolled steel sheet.

By performing the pickling, oxide scale on the surface of the hot-rolled steel sheet is removed, and the chemical convertibility and plating properties of the cold-rolled steel sheet can be improved. The pickling may be performed under known conditions, and may be performed once or separately performed a plurality of times.

The rolling reduction of the cold rolling is not particularly limited. For example, the rolling reduction is 20% to 80%. The cold rolling may also be performed a plurality of times.

### (Annealing Step)

In the annealing step, the cold-rolled steel sheet after the cold rolling step is retained and annealed at an annealing temperature of 830° C. or higher and lower than 900° C. for 25 to 100 seconds.

In addition, in the course of heating to the annealing temperature, the average rate of temperature increase from the start of heating (for example, room temperature: about 25° C.) to 700° C. is set to 15 to 100° C./sec, and the average rate of temperature increase from 700° C. to the annealing temperature is set to 5.0° C./sec or higher and lower than 15.0° C./sec.

In addition, in the course of cooling after retention at the annealing temperature, the steel sheet is cooled to a temperature range of 650° C. to 500° C. at an average cooling rate of 30 to 100° C./sec (primary cooling), and in this temperature range, the steel sheet is retained for longer than 200 seconds and 10,000 seconds or shorter. After retention, the steel sheet is cooled to 50° C. or lower (for example, room temperature) at an average cooling rate of 50 to 100° C./sec (secondary cooling).

In this step, through heating, fine austenite is generated from fine pearlite and cementite having a predetermined size as nuclei, and through cooling and retention at an intermediate temperature, a structure mainly including fine pearlite is obtained. In a case where the pearlite is made finer and the block boundaries and the colony boundaries are increased, it is possible to make the cementite to be formed on the block boundaries and the colony boundaries finer.

In the course of heating, in a case where the average rate of temperature increase to 700° C. is lower than 15° C./sec, the cementite coarsens during the temperature rise, and in the microstructure to be obtained after annealing, the pearlite substructures are likely to coarsen. As a result, the cementite on the block boundaries and the colony boundaries coarsen. Meanwhile, in order to raise the average rate of temperature increase to higher than 100° C./sec, a special device is required, which significantly increases the production cost.

In addition, in a case where the average rate of temperature increase from 700° C. to the annealing temperature is lower than 5.0° C./sec, the austenite structure may coarsen, and in the microstructure to be obtained after annealing, the cementite may coarsen and the hydrogen embrittlement resistance properties may deteriorate. Meanwhile, in a case where the average rate of temperature increase is 15.0° C./sec or higher, the recrystallization of the ferrite may be delayed and the nucleation of the austenite may be delayed, so the area ratio of pearlite may decrease in the microstructure to be obtained after annealing.

In addition, in a case where the annealing temperature (maximum reaching temperature) is lower than 830° C., austenitizing does not sufficiently proceed, and the area ratio of pearlite decreases in the microstructure to be obtained after annealing. Meanwhile, in a case where the annealing temperature is 900° C. or higher, the austenite structure may excessively coarsen, and in the microstructure to be obtained after annealing, the cementite may coarsen and the hydrogen embrittlement resistance properties may deteriorate.

In addition, in a case where the retention time at the annealing temperature is shorter than 25 seconds, austenitizing may not be sufficient. Meanwhile, in a case where the retention time is longer than 100 seconds, the austenite may coarsen, and in the microstructure to be obtained after annealing, the cementite may coarsen and the hydrogen embrittlement resistance properties may deteriorate.

In the course of cooling after retention at the annealing temperature, in a case where the average cooling rate to the temperature range of 650° C. to 500° C. is lower than 30° C./sec, ferrite is excessively formed, and in the microstructure to be obtained after annealing, a sufficient pearlite area ratio cannot be obtained. Meanwhile, in order to raise the average cooling rate to higher than 100° C./sec, a special cooling medium is required, which increases the production cost.

In addition, in a case where the cooling stop temperature (retention temperature) is higher than 650° C., ferrite is likely to be formed. In addition, coarse cementite is likely to be formed, and the hydrogen embrittlement resistance properties may deteriorate. Meanwhile, in a case where the cooling stop temperature (retention temperature) is lower than 500° C., the progress of pearlitic transformation may be delayed and the area ratio of bainite or martensite may increase, so the hydrogen embrittlement resistance properties may deteriorate.

In addition, in a case where the retention time in the temperature range of 650° C. to 500° C. is 200 seconds or shorter, pearlitic transformation does not sufficiently proceed. Meanwhile, in a case where the retention time is longer than 10,000 seconds, the cementite formed on the block boundaries and the colony boundaries may grow and the hydrogen embrittlement resistance properties may deteriorate.

In a case where the average cooling rate to 50° C. or lower is lower than 50° C./sec after retention in the temperature range of 650° C. to 500° C., the cementite formed on the block boundaries and the colony boundaries may grow and the hydrogen embrittlement resistance properties may deteriorate. Meanwhile, in a case where the average cooling rate is higher than 100° C./sec, a special cooling medium is required, which increases the production cost.

The steel sheet manufacturing method according to the present embodiment may include a coating layer forming step of forming a coating layer on the surface (one or both) of the steel sheet.

The coating layer is preferably a coating layer containing zinc, aluminum, magnesium, or an alloy of these metals. The coating layer is, for example, a plating layer.

The coating method is not limited. However, for example, in a case where a coating layer mainly containing zinc is formed by hot-dip plating, conditions therefor are as follows: the steel sheet temperature of the cold-rolled steel sheet is adjusted to be (plating bath temperature-40° C.) to (plating bath temperature+50)° C. (by performing heating or cooling); and then the steel sheet is immersed in the plating bath at 450° C. to 490° C. to form a plating layer.

The reasons why the above conditions are preferable are that in a case where the steel sheet temperature in the immersion in the plating bath is lower than hot-dip galvanizing bath temperature-40° C., the heat removed during the immersion in the plating bath may be large and a part of the molten zinc may solidify, deteriorating the appearance of the plating, and in a case where the steel sheet temperature in the immersion in the plating bath is higher than hot-dip galvanizing bath temperature+50° C., operational problems are generated due to an increase in temperature of the plating bath.

In the formation of a plating layer mainly containing zinc, the effective Al content (the value obtained by subtracting the total Fe content from the total Al content in the plating bath) in the composition of the plating bath is preferably 0.050 to 0.250 mass %. In addition, Mg is preferably contained as necessary and the remainder is preferably Zn and impurities. In a case where the effective Al content in the plating bath is less than 0.050 mass %, the intrusion of Fe into the plating layer may proceed excessively, leading to a decrease in plating adhesion. Meanwhile, in a case where the effective Al content in the plating bath is more than 0.250 mass %, Al-based oxides inhibiting the movement of Fe atoms and Zn atoms may be formed at the boundary between the steel sheet and the plating layer, leading to a decrease in plating adhesion.

The above-described coating layer forming step may be performed after the above-described annealing step or during the annealing cooling step. That is, in the course of cooling in the annealing step, the coating layer forming step may be performed during the cooling to 50° C. or lower after retention at 500° C. to 650° C., as long as the average cooling rate satisfies 50 to 100° C./sec.

In the formation of a plating layer mainly containing zinc as the coating layer, an alloying treatment may be further performed (alloying step). Conditions for this case include, for example, retaining the steel sheet with a plating layer formed thereon at 480° C. to 550° C. for 1 to 30 seconds.

The alloying step may also be performed in the course of cooling in the annealing step described above.

For the purpose of improving coatability and weldability, the surface of the coating layer may be subjected to upper layer plating or various treatments such as a chromate treatment, a phosphate treatment, a lubricity improvement treatment, and a weldability improvement treatment.

### EXAMPLES

Examples of the present invention will be shown below. The examples to be shown below are merely examples of the present invention, and the present invention is not limited thereto.

Steels having chemical compositions shown in Tables 1A to 1D were melted and cast into steel pieces. The steel pieces were heated to 1,150° C., retained for 60 minutes, taken out into the air, and hot-rolled to obtain steel sheets having a sheet thickness of 3.0 mm. In the hot rolling, finish rolling was performed six times (six passes) in total, and among the passes, 4 rolling passes were performed with a rolling reduction higher than 20%. In the finish rolling, the interpass time was set to 0.5 seconds. In the finish rolling, the start temperature was 1,050° C. and the finishing temperature was 900° C. The steel sheets were cooled by water 0.6 seconds after completion of the finish rolling, cooled to 550° C. at an average cooling rate of 19.0° C./sec, and then coiled.

Subsequently, oxide scale on the hot-rolled steel sheets was removed by pickling, and the steel sheets were cold-rolled with a rolling reduction of 50.0% to obtain cold-rolled steel sheets having a sheet thickness of 1.5 mm.

Furthermore, the cold-rolled steel sheets were heated from room temperature to 700° C. at an average rate of temperature increase of 25.0° C./sec and heated from 700° C. to 860° C. at an average rate of temperature increase of 8° C./sec. After retention at 860° C. for 75 seconds, the steel sheets were cooled to 620° C. at an average cooling rate of 43.0° C./sec. After retention at 620° C. for 350 seconds, the steel sheets were cooled to room temperature at an average cooling rate of 55° C./sec.

No plating was performed.

A microstructure of the obtained cold-rolled steel sheet was observed in the above-described manner to obtain an area ratio of each phase (ferrite, pearlite, and remainder (bainite, martensite, and/or residual austenite)) in a t/4 portion. In addition, in the t/4 portion, of granular cementites on block boundaries and colony boundaries, the maximum diameter and the number (number density) of grains per unit length on the boundaries were obtained.

The results are shown in Tables 2A and 2B.

In addition, the chemical compositions obtained by analyzing the samples collected from the manufactured steel sheets were the same as the chemical compositions of the steels shown in Tables 1A to 1D.

In addition, tensile properties and hydrogen embrittlement resistance properties of the obtained cold-rolled steel sheets were evaluated in the following manner.

### (Method of Evaluating Tensile Properties)

A JIS No. 5 test piece was collected from a direction in which the longitudinal direction of the test piece was parallel to the orthogonal-to-rolling direction of the steel strip, and a tensile test was performed according to JIS Z 2241 (2011) to measure a tensile strength (TS) and a total elongation (El).

### (Method of Evaluating Hydrogen Embrittlement Resistance Properties)

The steel sheet was sheared with a clearance of 12.5%, and then a U-bending test was performed at 10R. A strain gauge was attached to the center of the obtained test piece, and a stress was applied by tightening both ends of the test piece with bolts. The applied stress was calculated from the monitored strain in the strain gauge. As a load stress, a stress corresponding to 80% of the tensile strength (TS) was applied (for example, in a case of A-0 in Table 2A, applied stress=1,720 MPa x 0.8=1,376 MPa). This is because the residual stress that is introduced during forming is considered to correspond to the tensile strength of the steel sheet.

The obtained U-bending test piece was immersed in an HCl aqueous solution having a pH of 3 at a liquid temperature of 25° C. and retained for 96 hours, and the presence or absence of cracking was investigated. The lower the pH of the HCl aqueous solution and the longer the immersion time, the larger the amount of hydrogen intruding into the steel sheet. Therefore, the hydrogen embrittlement environment becomes severe.

After the immersion, a case where a crack having a length longer than 1.0 mm was recognized in the U-bending test piece was evaluated as NG, and a case where no crack having a length longer than 1.0 mm was recognized was evaluated as OK.

A steel sheet having a tensile strength of 1,200 MPa or more and evaluated as OK in terms of hydrogen embrittlement resistance properties was evaluated to have a high strength and excellent hydrogen embrittlement resistance properties.

TABLE 1A

| | Mass %, Remainder: Fe and Impurities | | | | | | |
|---|---|---|---|---|---|---|---|
| No. | C | Si | Mn | P | S | Al | N |
| A | 0.369 | 1.13 | 1.48 | 0.0166 | 0.0034 | 0.228 | 0.0190 |
| B | 0.232 | 1.78 | 0.93 | 0.0180 | 0.0026 | 0.736 | 0.0120 |
| C | 0.394 | 1.41 | 1.17 | 0.0186 | 0.0158 | 0.472 | 0.0150 |
| D | 0.240 | 0.57 | 1.99 | 0.0105 | 0.0171 | 0.891 | 0.0100 |
| E | 0.210 | 0.78 | 1.80 | 0.0112 | 0.0100 | 0.159 | 0.0080 |
| F | 0.292 | 1.54 | 1.30 | 0.0088 | 0.0180 | 0.023 | 0.0120 |
| G | 0.164 | 1.69 | 1.64 | 0.0158 | 0.0115 | 0.435 | 0.0010 |
| H | 0.175 | 1.90 | 0.99 | 0.0077 | 0.0064 | 0.620 | 0.0040 |
| I | 0.186 | 0.97 | 1.56 | 0.0140 | 0.0006 | 0.823 | 0.0140 |
| J | 0.279 | 0.11 | 1.08 | 0.0035 | 0.0132 | 0.135 | 0.0170 |
| K | 0.361 | 0.48 | 0.88 | 0.0056 | 0.0069 | 0.395 | 0.0090 |
| L | 0.310 | 0.32 | 1.25 | 0.0129 | 0.0044 | 0.333 | 0.0020 |
| M | 0.324 | 0.83 | 1.74 | 0.0005 | 0.0135 | 0.942 | 0.0060 |
| N | 0.343 | 0.21 | 1.37 | 0.0044 | 0.0188 | 0.716 | 0.0180 |
| O | 0.259 | 1.32 | 1.84 | 0.0021 | 0.0083 | 0.585 | 0.0050 |
| P | 0.144 | 1.13 | 1.92 | 0.0185 | 0.0038 | 0.667 | 0.0180 |
| Q | 0.406 | 0.25 | 0.94 | 0.0099 | 0.0022 | 0.697 | 0.0160 |
| R | 0.386 | 2.08 | 1.57 | 0.0100 | 0.0072 | 0.931 | 0.0090 |
| S | 0.178 | 1.22 | 0.77 | 0.0143 | 0.0039 | 0.427 | 0.0100 |
| T | 0.164 | 1.77 | 2.03 | 0.0077 | 0.0171 | 0.305 | 0.0140 |
| U | 0.230 | 1.10 | 1.57 | 0.0204 | 0.0030 | 0.295 | 0.0190 |
| V | 0.358 | 0.70 | 1.82 | 0.0042 | 0.0205 | 0.318 | 0.0040 |
| W | 0.260 | 1.26 | 1.70 | 0.0098 | 0.0046 | 1.034 | 0.0020 |
| X | 0.345 | 0.71 | 1.92 | 0.0015 | 0.0177 | 0.676 | 0.0210 |
| Y | 0.382 | 1.12 | 1.39 | 0.0043 | 0.0089 | 0.782 | 0.0060 |
| Z | 0.224 | 0.36 | 1.88 | 0.0055 | 0.0016 | 0.370 | 0.0190 |
| AA | 0.341 | 0.57 | 1.36 | 0.0154 | 0.0165 | 0.553 | 0.0030 |

TABLE 1B

| | Mass %, Remainder: Fe and Impurities | | | | | | | |
|---|---|---|---|---|---|---|---|---|
| No. | O | Cr | Co | Ni | Mo | Ti | B | Nb |
| A | 0.0088 | 1.879 | 0.324 | 0.851 | | | | |
| B | 0.0078 | 3.693 | | | 0.9895 | 0.066 | 0.007 | |
| C | 0.0118 | 3.361 | | | 0.1503 | 0.150 | 0.001 | 0.414 |
| D | 0.0191 | 3.099 | | 0.341 | | | | |
| E | 0.0129 | 2.497 | | | | 0.126 | | 0.203 |
| F | 0.0136 | 2.796 | | | | | | 0.471 |
| G | 0.0179 | 3.041 | | | 0.0784 | | | |
| H | 0.0095 | 1.308 | | | | | | |
| I | 0.0169 | 0.948 | 0.160 | 0.628 | | | | |
| J | 0.0151 | 3.892 | | | | | | |
| K | 0.0033 | 2.215 | | | | | | |
| L | 0.0006 | 1.915 | | | 0.8282 | | | |
| M | 0.0065 | 0.720 | | | | | | |
| N | 0.0043 | 1.189 | | | | | | |
| O | 0.0022 | 1.648 | | | | | | |
| P | 0.0044 | 2.482 | 0.056 | 0.437 | | | | |
| Q | 0.0103 | 1.567 | | | | | | |
| R | 0.0091 | 1.964 | 0.375 | | | | | |
| S | 0.0109 | 2.573 | 0.306 | | | | | |
| T | 0.0099 | 2.370 | | | | 0.303 | 0.007 | |
| U | 0.0130 | 2.835 | | | 0.6244 | | | 0.359 |
| V | 0.0070 | 1.060 | | | 0.1664 | | | |
| W | 0.0173 | 1.247 | | 0.219 | | | | |
| X | 0.0160 | 2.500 | | | | | | |
| Y | 0.0207 | 1.055 | | | | | | |
| Z | 0.0190 | 0.388 | | | | | | |
| AA | 0.0075 | 4.134 | | | | | 0.004 | 0.238 |

TABLE 1C

| | Mass %, Remainder: Fe and Impurities | | | | | | |
|---|---|---|---|---|---|---|---|
| No. | V | Cu | W | Ta | Sn | Sb | As |
| A | | | | | | | |
| B | | | | | | | |
| C | | | | | | | |
| D | | 0.062 | | | 0.017 | | |
| E | | | | | | 0.045 | |
| F | 0.113 | | | | | | |
| G | | | 0.068 | 0.098 | | | |
| H | | 0.031 | | | 0.019 | 0.023 | |
| I | | 0.475 | | | | | |
| J | | | | | | | |
| K | | | | | | | 0.030 |
| L | | | | | | | |
| M | 0.388 | 0.248 | | | | | |
| N | 0.091 | | | | | | |
| O | | | | | | | |
| P | | | | | | | |
| Q | 0.050 | | | | | | 0.042 |
| R | | | | | 0.011 | | |
| S | 0.467 | 0.216 | | | | | |
| T | | | 0.032 | | | | |
| U | | | 0.092 | | | | |
| V | | | | 0.082 | | 0.048 | |
| W | | | | | | | |
| X | | | | | 0.011 | | |
| Y | | | | | | | |
| Z | | | | | 0.005 | | |
| AA | | | | | | | |

TABLE 1D

Mass %, Remainder: Fe and Impurities

| No. | Mg | Ca | Y | Zr | La | Ce |
|---|---|---|---|---|---|---|
| A | | | | | | |
| B | | | | 0.015 | | |
| C | | | | | | |
| D | | | | | | |
| E | | | | | | |
| F | | | | | | |
| G | | | | | | |
| H | | | | | | |
| I | | | | | | |
| J | | 0.039 | | | | |
| K | 0.039 | 0.016 | | | | |
| L | | | | | 0.048 | 0.032 |
| M | | | 0.045 | | | |
| N | | | | 0.004 | | |
| O | | | | | | |
| P | | | | | | |
| Q | | | | | | |
| R | | | | | | 0.004 |
| S | | | | | | |
| T | | | | | | |
| U | | | | | | |
| V | | | | | | |
| W | | | | 0.034 | | |
| X | 0.028 | 0.023 | | | | |
| Y | | | | | 0.039 | 0.013 |
| Z | | | | | | |
| AA | | | 0.025 | | | |

TABLE 2A

| | | | | | Tensile | Total |
|---|---|---|---|---|---|---|
| | Steel | Ferrite | Pearlite | Remainder | Strength | Elongation |
| No. | Type | (area %) | (area %) | (area %) | (MPa) | (%) |
| A-0 | A | 0.0 | 100.0 | 0.0 | 1720 | 8.4 |
| B-0 | B | 0.0 | 96.0 | 4.0 | 1424 | 10.2 |
| C-0 | C | 0.0 | 91.0 | 9.0 | 1824 | 7.7 |
| D-0 | D | 1.1 | 93.0 | 5.9 | 1498 | 9.2 |
| E-0 | E | 0.0 | 100.0 | 0.0 | 1243 | 11.8 |
| F-0 | F | 0.0 | 100.0 | 0.0 | 1370 | 12.2 |
| G-0 | G | 4.5 | 95.5 | 0.0 | 1246 | 12.8 |
| H-0 | H | 7.5 | 92.5 | 0.0 | 1296 | 10.3 |
| I-0 | I | 4.9 | 94.0 | 1.1 | 1366 | 9.7 |
| J-0 | J | 1.6 | 98.0 | 0.4 | 1721 | 7.3 |
| K-0 | M | 1.8 | 93.0 | 5.2 | 1861 | 7.9 |
| L-0 | L | 0.0 | 94.0 | 6.0 | 1600 | 8.2 |
| M-0 | M | 0.0 | 92.0 | 8.0 | 1610 | 9.5 |
| N-0 | N | 0.0 | 97.0 | 3.0 | 1628 | 7.2 |
| O-0 | O | 1.9 | 92.0 | 6.1 | 1523 | 10.4 |
| P-0 | P | 6.0 | 94.0 | 0.0 | 1034 | 15.3 |
| Q-0 | Q | 2.2 | 97.8 | 0.0 | 1800 | 5.9 |
| R-0 | R | 1.6 | 96.0 | 2.4 | 1661 | 8.5 |
| S-0 | S | 5.0 | 95.0 | 0.0 | 987 | 13.3 |
| T-0 | T | 1.6 | 92.0 | 6.4 | 1245 | 12.5 |
| U-0 | U | 0.0 | 94.0 | 6.0 | 1385 | 11.4 |
| V-0 | V | 2.2 | 91.0 | 6.8 | 1695 | 6.7 |
| W-0 | W | 0.0 | 96.0 | 4.0 | 1443 | 7.8 |
| X-0 | X | 0.0 | 100.0 | 0.0 | 1867 | 6.7 |
| Y-0 | Y | 3.1 | 92.0 | 4.9 | 1506 | 8.1 |
| Z-0 | Z | 17.6 | 82.4 | 0.0 | 799 | 15.6 |
| AA-0 | AA | 0.0 | 91.0 | 9.0 | 1567 | 7.6 |

TABLE 2B

| | | Maximum Diameter | Number Density of | | |
|---|---|---|---|---|---|
| | | of Granular | Grains of Granular | Hydrogen | |
| | | Cementites on | Cementites on | Embrittlement | |
| | Steel | Boundaries | Boundaries | Resistance | |
| No. | Type | (μm) | (pieces/μm) | Properties | Remarks |
| A-0 | A | 0.32 | 1.8 | OK | Invention Example |
| B-0 | B | 0.27 | 0.7 | OK | Invention Example |
| C-0 | C | 0.05 | 1.0 | OK | Invention Example |
| D-0 | D | 0.14 | 2.9 | OK | Invention Example |
| E-0 | E | 0.28 | 1.1 | OK | Invention Example |
| F-0 | F | 0.42 | 2.6 | OK | Invention Example |
| G-0 | G | 0.24 | 0.8 | OK | Invention Example |
| H-0 | H | 0.39 | 0.9 | OK | Invention Example |
| I-0 | I | 0.17 | 0.6 | OK | Invention Example |
| J-0 | J | 0.36 | 0.6 | OK | Invention Example |
| K-0 | K | 0.14 | 2.8 | OK | Invention Example |
| L-0 | L | 0.19 | 1.5 | OK | Invention Example |
| M-0 | M | 0.10 | 2.4 | OK | Invention Example |
| N-0 | N | 0.44 | 2.5 | OK | Invention Example |
| O-0 | O | 0.29 | 0.4 | OK | Invention Example |
| P-0 | P | 0.10 | 1.6 | NG | Comparative Example |
| Q-0 | Q | 0.15 | 2.7 | NG | Comparative Example |
| R-0 | R | 0.42 | 2.2 | NG | Comparative Example |
| S-0 | S | 0.37 | 1.9 | OK | Comparative Example |
| T-0 | T | 0.26 | 1.2 | NG | Comparative Example |
| U-0 | U | 0.43 | 1.9 | NG | Comparative Example |
| V-0 | V | 0.22 | 1.2 | NG | Comparative Example |
| W-0 | W | 0.09 | 1.3 | NG | Comparative Example |
| X-0 | X | 0.19 | 2.1 | NG | Comparative Example |
| Y-0 | Y | 0.03 | 2.3 | NG | Comparative Example |
| Z-0 | Z | 0.46 | 0.7 | OK | Comparative Example |
| AA-0 | AA | 0.27 | 2.5 | NG | Comparative Example |

As can be seen from Tables 1A to 2B, Nos. A-0 to O-0 were within the ranges of the present invention in terms of chemical composition, area ratio of the microstructure, maximum diameter of cementite present on block boundaries and colony boundaries, and number density of grains of granular cementites present on block boundaries and colony boundaries, and had an excellent tensile strength and excellent hydrogen embrittlement resistance properties.

On the other hand, Nos. P-0 to AA-0 were outside the ranges of the present invention in terms of chemical composition, and were thus inferior in either one or more of the tensile strength and the hydrogen embrittlement resistance properties.

In P-0, since the C content was low, the tensile strength was less than 1,200 MPa, and the hydrogen embrittlement resistance properties also decreased.

In Q-0, since the C content was high, the hydrogen embrittlement resistance properties decreased.

In R-0, since the Si content was high, the hydrogen embrittlement resistance properties decreased.

In S-0, since the Mn content was low, the tensile strength was less than 1,200 MPa.

In T-0, since the Mn content was high, the hydrogen embrittlement resistance properties deteriorated.

In U-0, since the P content was high, the hydrogen embrittlement resistance properties decreased due to embrittlement of the grain boundaries.

In V-0, since the S content was high, coarse sulfides were formed and the hydrogen embrittlement resistance properties decreased.

In W-0, since the Al content was high, coarse Al oxides were formed and the hydrogen embrittlement resistance properties decreased.

In X-0, since the N content was high, coarse nitrides were formed and the hydrogen embrittlement resistance properties decreased.

In Y-0, since the O content was high, oxides were formed and the hydrogen embrittlement resistance properties decreased.

In Z-0, since the Cr content was low, the area ratio of pearlite decreased, and the tensile strength was less than 1,200 MPa.

In AA-0, since the Cr content was high, coarse Cr carbides were formed and the hydrogen embrittlement resistance properties decreased.

### Example 2

Furthermore, in order to investigate the influences of manufacturing conditions, hot-rolled steel sheets were produced under manufacturing conditions shown in Tables 3A to 3D using the steel types A to O recognized to have excellent properties in Tables 2A and 2B. In that case, the maximum interpass time between a large reduction pass and a large reduction pass immediately before the large reduction pass was as shown in Tables 3A and 3B.

The hot-rolled steel sheets were cold-rolled with rolling reductions shown in Tables 3A and 3B to produce cold-rolled steel sheets, and then annealed under conditions shown in Tables 3C and 3D. After primary cooling, the steel sheets were retained for times shown in Tables 3C and 3D in a range of cooling stop temperature #10° C. In secondary cooling, the stop temperature was set to room temperature.

In addition, some of the cold-rolled steel sheets were plated to form a zinc plated layer on their surfaces. Here, the plating type symbols GI and GA in Tables 3A to 3D represent galvanizing methods. GI indicates a steel sheet in which a galvanized layer is formed on a surface of the steel sheet by immersing the steel sheet in a hot-dip galvanizing bath at 455° C., and GA indicates a steel sheet in which an iron-zinc alloy layer (hot-dip galvannealed layer) is formed on a surface of the steel sheet by immersing the steel sheet in a hot-dip galvanizing bath at 465° C. and by then raising the temperature of the steel sheet to 490° C.

A microstructure of the obtained cold-rolled steel sheet was observed in the same manner as in Example 1 to obtain an area ratio of each phase in a t/4 portion. In addition, in the t/4 portion, the maximum diameter and the number density of grains of granular cementites on block boundaries and colony boundaries were obtained.

In addition, tensile properties and hydrogen embrittlement resistance properties of the obtained cold-rolled steel sheets were evaluated in the same manner as in Example 1.

The obtained results are shown in Tables 4A and 4B.

TABLE 3A

| | | | Hot Rolling Step | | | | | | | |
|---|---|---|---|---|---|---|---|---|---|---|
| | | | | | Number of | | Cooling Step | | | Cold |
| | | | | | Large | Maximum | Time from | | | Rolling |
| | | Heating | | | Reduction | Interpass | Completion | | | Step |
| | | Step | | | Passes with | Time | of Hot | | Coiling | Cold |
| | | Slab | Rolling | | Rolling | between | Rolling | Average | Step | Rolling |
| | | Heating | Start | Finish | Reduction | Large | to Start | Cooling | Coiling | Reduction |
| | Steel | Temperature | Temperature | Temperature | of 20% | Reduction | of Cooling | Rate | Temperature | Ratio |
| No. | Type | (° C.) | (° C.) | (° C.) | or More | Passes | (sec) | (° C./sec) | (° C.) | (%) |
| A-1 | A | 1003 | 1086 | 833 | 4 | 2.9 | 0.5 | 12.4 | 587 | 48 |
| B-1 | B | 1215 | 972 | 902 | 4 | 4.3 | 0.9 | 8.5 | 577 | 55 |
| C-1 | C | 1091 | 1093 | 884 | 7 | 0.4 | 0.4 | 11.4 | 503 | 78 |
| D-1 | D | 1025 | 1056 | 917 | 6 | 4.7 | 0.2 | 14.2 | 536 | 61 |
| E-1 | E | 1125 | 1001 | 937 | 5 | 3.4 | 0.7 | 14.8 | 568 | 64 |
| F-1 | F | 1242 | 997 | 827 | 4 | 0.8 | 0.8 | 18.2 | 438 | 23 |
| G-1 | G | 1149 | 1060 | 842 | 4 | 1.4 | 0.8 | 7.8 | 403 | 71 |
| H-1 | H | 1064 | 956 | 890 | 4 | 0.2 | 0.3 | 16.7 | 469 | 38 |
| I-1 | I | 1111 | 961 | 945 | 4 | 2.5 | 0.5 | 19.3 | 523 | 30 |
| J-1 | J | 1173 | 983 | 852 | 5 | 1.9 | 0.1 | 5.9 | 442 | 75 |
| K-1 | K | 1277 | 1016 | 877 | 6 | 1.3 | 0.4 | 13.2 | 484 | 59 |
| L-1 | L | 1292 | 1046 | 924 | 6 | 3.2 | 0.6 | 4.6 | 517 | 25 |
| M-1 | M | 1193 | 1023 | 818 | 7 | 4.4 | 0.6 | 9.7 | 555 | 36 |
| N-1 | N | 1050 | 1071 | 802 | 7 | 3.7 | 0.3 | 7.2 | 465 | 42 |
| O-1 | O | 1231 | 1031 | 866 | 8 | 2.1 | 0.9 | 17.2 | 423 | 50 |

TABLE 3B

| | | | Hot Rolling Step | | | | | | | |
|---|---|---|---|---|---|---|---|---|---|---|
| | | | | | Number of | Maximum | Cooling Step | | | Cold |
| | | | | | Large | Interpass | Time from | | | Rolling |
| | | | | | Reduction | Time | Completion | | | Step |
| | | Heating | | | Passes with | between | of Hot | | Coiling | Cold |
| | | Step Slab | Rolling | | Rolling | Large | Rolling | Average | Step | Rolling |
| | | Heating | Start | Finish | Reduction | Reduction | to Start | Cooling | Coiling | Reduction |
| | Steel | Temperature | Temperature | Temperature | of 20% | Passes | of Cooling | Rate | Temperature | Ratio |
| No. | Type | (° C.) | (° C.) | (° C.) | or More | (sec) | (sec) | (° C./sec) | (° C.) | (%) |
| A-2 | A | 1211 | 1106 | 812 | 6 | 3.4 | 0.6 | 9.8 | 406 | 59 |
| B-2 | B | 1146 | 1007 | 955 | 6 | 4.5 | 0.7 | 16.8 | 493 | 62 |
| C-2 | C | 1232 | 1028 | 879 | 3 | 4.4 | 0.7 | 5.0 | 520 | 60 |
| D-2 | D | 1262 | 999 | 924 | 4 | 5.1 | 0.1 | 18.7 | 494 | 25 |
| E-2 | E | 1069 | 1037 | 942 | 6 | 1.2 | 1.6 | 17.5 | 439 | 22 |
| F-2 | F | 1129 | 967 | 889 | 5 | 4.1 | 0.2 | 3.6 | 533 | 29 |
| G-2 | G | 1034 | 1053 | 909 | 5 | 1.0 | 0.4 | 20.6 | 456 | 26 |
| H-2 | H | 1041 | 1045 | 920 | 5 | 3.0 | 0.3 | 11.1 | 392 | 44 |
| I-2 | I | 1176 | 1059 | 849 | 7 | 3.0 | 0.6 | 18.9 | 644 | 70 |
| J-2 | J | 1035 | 1060 | 857 | 6 | 4.8 | 0.4 | 16.4 | 561 | 52 |
| K-2 | K | 1144 | 1049 | 831 | 5 | 1.4 | 0.2 | 14.8 | 413 | 30 |
| L-2 | L | 1289 | 1027 | 928 | 6 | 4.0 | 0.4 | 7.3 | 567 | 56 |
| M-2 | M | 1109 | 1027 | 851 | 6 | 3.7 | 0.6 | 17.4 | 547 | 44 |
| N-2 | N | 1118 | 1014 | 894 | 8 | 1.9 | 0.4 | 14.7 | 551 | 33 |
| O-2 | O | 1133 | 981 | 938 | 7 | 2.5 | 0.9 | 6.8 | 530 | 71 |
| A-3 | A | 1192 | 959 | 892 | 5 | 0.3 | 0.8 | 6.6 | 480 | 50 |
| B-3 | B | 1025 | 1023 | 877 | 7 | 4.8 | 0.5 | 12.8 | 578 | 35 |
| C-3 | C | 1092 | 1006 | 814 | 6 | 1.0 | 0.9 | 8.8 | 534 | 68 |
| D-3 | D | 1228 | 1078 | 839 | 5 | 4.1 | 0.6 | 11.5 | 562 | 64 |
| E-3 | E | 1186 | 976 | 911 | 7 | 0.9 | 0.2 | 8.6 | 583 | 42 |
| F-3 | F | 1242 | 962 | 917 | 4 | 0.5 | 0.5 | 13.7 | 594 | 30 |

TABLE 3C

| | | Annealing Step | | | | | | | | |
|---|---|---|---|---|---|---|---|---|---|---|
| | | | Average | | | | | Retention | | |
| | | | Rate of | | | | | Time at | | |
| | | Average | Temperature | | | Average | | Primary | Average | Coating |
| | | Rate of | Increase | | Retention | Cooling | Primary | Cooling | Cooling | Layer |
| | | Temperature | from 700° C. | | Time at | Rate in | Cooling | Stop | Rate in | Forming |
| | | Increase | to Annealing | Annealing | Annealing | Primary | Stop | Temperature | Secondary | Step |
| | Steel | to 700° C. | Temperature | Temperature | Temperature | Cooling | Temperature | (±10° C.) | Cooling | Plating |
| No. | Type | (° C./sec) | (° C./sec) | (° C.) | (sec) | (° C./sec) | (° C.) | (sec) | (° C./sec) | Type |
| A-1 | A | 47 | 7.2 | 865 | 63 | 57 | 604 | 955 | 86 | — |
| B-1 | B | 95 | 11.4 | 899 | 79 | 42 | 640 | 775 | 88 | GA |
| C-1 | C | 70 | 10.6 | 888 | 84 | 84 | 616 | 440 | 57 | GA |
| D-1 | D | 29 | 9.1 | 882 | 34 | 88 | 559 | 250 | 77 | GI |
| E-1 | E | 82 | 6.2 | 877 | 59 | 36 | 562 | 1200 | 83 | GA |
| F-1 | F | 59 | 10.0 | 842 | 71 | 79 | 623 | 2200 | 69 | GI |
| G-1 | G | 53 | 8.0 | 862 | 37 | 60 | 633 | 850 | 97 | — |
| H-1 | H | 76 | 11.7 | 838 | 50 | 52 | 574 | 950 | 62 | — |
| I-1 | I | 36 | 8.4 | 852 | 88 | 73 | 543 | 256 | 72 | — |
| J-1 | J | 20 | 12.5 | 873 | 29 | 95 | 522 | 375 | 51 | — |
| K-1 | K | 84 | 6.7 | 833 | 97 | 31 | 535 | 367 | 76 | GA |
| L-1 | L | 64 | 13.7 | 857 | 93 | 65 | 510 | 1261 | 56 | GA |
| M-1 | M | 25 | 14.8 | 846 | 53 | 71 | 596 | 6000 | 91 | GA |
| N-1 | N | 39 | 13.1 | 871 | 45 | 91 | 589 | 2500 | 94 | — |
| O-1 | O | 93 | 5.4 | 891 | 67 | 47 | 517 | 350 | 65 | — |

TABLE 3D

| | | Annealing Step | | | | | | | | |
|---|---|---|---|---|---|---|---|---|---|---|
| | | | Average | | | | | Retention | | |
| | | | Rate of | | | | | Time at | | |
| | | Average | Temperature | | | Average | | Primary | Average | Coating |
| | | Rate of | Increase | | Retention | Cooling | Primary | Cooling | Cooling | Layer |
| | | Temperature | from 700° C. | | Time at | Rate in | Cooling | Stop | Rate in | Forming |
| | | Increase | to Annealing | Annealing | Annealing | Primary | Stop | Temperature | Secondary | Step |
| | Steel | to 700° C. | Temperature | Temperature | Temperature | Cooling | Temperature | (±10° C.) | Cooling | Plating |
| No. | Type | (° C./sec) | (° C./sec) | (° C.) | (sec) | (° C./sec) | (° C.) | (sec) | (° C./sec) | Type |
| A-2 | A | 48 | 7.5 | 835 | 78 | 67 | 643 | 3500 | 86 | GI |
| B-2 | B | 68 | 13.8 | 873 | 89 | 33 | 642 | 450 | 64 | GA |
| C-2 | C | 34 | 7.2 | 848 | 89 | 65 | 518 | 1300 | 61 | GA |
| D-2 | D | 60 | 14.2 | 893 | 66 | 48 | 561 | 1500 | 79 | GA |
| E-2 | E | 58 | 12.3 | 861 | 45 | 82 | 571 | 4000 | 58 | — |
| F-2 | F | 24 | 9.9 | 898 | 29 | 75 | 548 | 2100 | 70 | — |
| G-2 | G | 88 | 11.7 | 850 | 38 | 47 | 566 | 430 | 59 | — |
| H-2 | H | 23 | 9.1 | 836 | 95 | 62 | 561 | 2400 | 83 | GA |
| I-2 | I | 66 | 14.0 | 889 | 52 | 53 | 549 | 500 | 64 | GA |
| J-2 | J | 12 | 9.1 | 892 | 30 | 91 | 600 | 250 | 73 | GA |
| K-2 | K | 88 | 4.6 | 883 | 51 | 53 | 584 | 300 | 93 | GI |
| L-2 | L | 91 | 15.2 | 869 | 49 | 90 | 635 | 570 | 90 | GI |
| M-2 | M | 81 | 12.9 | 828 | 41 | 68 | 567 | 350 | 68 | GI |
| N-2 | N | 31 | 8.2 | 902 | 36 | 99 | 530 | 6000 | 76 | — |
| O-2 | O | 35 | 9.8 | 875 | 23 | 58 | 616 | 430 | 88 | — |
| A-3 | A | 64 | 8.7 | 842 | 103 | 80 | 527 | 900 | 89 | GA |
| B-3 | B | 34 | 5.6 | 888 | 37 | 28 | 507 | 5000 | 73 | GI |
| C-3 | C | 50 | 13.0 | 853 | 32 | 66 | 487 | 1200 | 84 | — |
| D-3 | D | 58 | 6.6 | 872 | 72 | 75 | 664 | 840 | 77 | GA |
| E-3 | E | 37 | 11.4 | 840 | 70 | 87 | 519 | 180 | 97 | GA |
| F-3 | F | 44 | 12.7 | 897 | 58 | 42 | 616 | 300 | 43 | GI |

TABLE 4A

| | | | | | Tensile | Total |
|---|---|---|---|---|---|---|
| | Steel | Ferrite | Pearlite | Remainder | Strength | Elongation |
| No. | Type | (area %) | (area %) | (area %) | (MPa) | (%) |
| A-1 | A | 0.0 | 100.0 | 0.0 | 1847 | 6.7 |
| B-1 | B | 7.0 | 93.0 | 0.0 | 1391 | 10.4 |
| C-1 | C | 4.0 | 94.0 | 2.0 | 1468 | 7.9 |
| D-1 | D | 7.0 | 93.0 | 0.0 | 1487 | 7.3 |
| E-1 | B | 0.0 | 100.0 | 0.0 | 1617 | 6.9 |
| F-1 | F | 0.0 | 100.0 | 0.0 | 1841 | 8.5 |
| G-1 | G | 2.0 | 98.0 | 0.0 | 1230 | 11.4 |
| H-1 | H | 6.0 | 94.0 | 0.0 | 1374 | 10.2 |
| I-1 | I | 5.0 | 95.0 | 0.0 | 1743 | 7.5 |
| J-1 | J | 0.0 | 94.0 | 6.0 | 1680 | 9.5 |
| K-1 | K | 0.0 | 96.0 | 4.0 | 1232 | 12.4 |
| L-1 | L | 0.0 | 92.0 | 8.0 | 1430 | 8.6 |
| M-1 | M | 9.0 | 91.0 | 0.0 | 1281 | 11.1 |
| N-1 | N | 9.0 | 91.0 | 0.0 | 1291 | 12.5 |
| O-1 | O | 4.0 | 91.0 | 5.0 | 1462 | 8.8 |
| A-2 | A | 2.0 | 98.0 | 0.0 | 1580 | 6.5 |
| B-2 | B | 7.0 | 93.0 | 0.0 | 1885 | 5.9 |
| C-2 | C | 0.0 | 100.0 | 0.0 | 1722 | 7.6 |
| D-2 | D | 7.0 | 93.0 | 0.0 | 1532 | 8.7 |
| E-2 | E | 0.0 | 100.0 | 0.0 | 1517 | 7.6 |
| F-2 | F | 13.5 | 86.5 | 0.0 | 1159 | 11.4 |
| G-2 | G | 0.0 | 100.0 | 0.0 | 1230 | 10.1 |
| H-2 | H | 0.0 | 100.0 | 0.0 | 1421 | 7.9 |
| I-2 | I | 0.0 | 87.0 | 13.0 | 1591 | 4.4 |
| J-2 | J | 6.0 | 94.0 | 0.0 | 1322 | 7.8 |
| K-2 | K | 4.0 | 96.0 | 0.0 | 1567 | 8.5 |
| L-2 | L | 8.0 | 87.5 | 4.5 | 1234 | 9.5 |
| M-2 | M | 2.0 | 88.0 | 10.0 | 1780 | 3.4 |
| N-2 | N | 0.0 | 100.0 | 0.0 | 1572 | 9.4 |
| O-2 | O | 0.0 | 82.0 | 18.0 | 1337 | 4.4 |
| A-3 | A | 2.0 | 98.0 | 0.0 | 1318 | 10.6 |
| B-3 | B | 15.5 | 84.5 | 0.0 | 1021 | 13.1 |
| C-3 | C | 0.0 | 83.0 | 17.0 | 1441 | 5.9 |
| D-3 | D | 11.2 | 86.0 | 2.8 | 1106 | 14.1 |
| E-3 | E | 0.0 | 87.0 | 13.0 | 1451 | 6.6 |
| F-3 | F | 1.0 | 99.0 | 0.0 | 1423 | 7.6 |

TABLE 4B

| | | | Number Density of | | |
|---|---|---|---|---|---|
| | | Maximum Diameter of | Grains of Granular | Hydrogen | |
| | | Granular Cementites on | Cementites on | Embrittlement | |
| | Steel | Boundaries | Boundaries | Resistance | |
| No. | Type | (μm) | (pieces/μm) | Properties | Remarks |
| A-1 | A | 0.34 | 2.5 | OK | Invention Example |
| B-1 | B | 0.23 | 2.5 | OK | Invention Example |
| C-1 | C | 0.43 | 1.4 | OK | Invention Example |
| D-1 | D | 0.19 | 0.6 | OK | Invention Example |
| E-1 | E | 0.44 | 0.9 | OK | Invention Example |
| F-1 | F | 0.38 | 0.5 | OK | Invention Example |
| G-1 | G | 0.37 | 1.8 | OK | Invention Example |
| H-1 | H | 0.31 | 2.5 | OK | Invention Example |
| I-1 | I | 0.48 | 4.2 | OK | Invention Example |
| J-1 | J | 0.33 | 3.1 | OK | Invention Example |
| K-1 | K | 0.12 | 2.8 | OK | Invention Example |
| L-1 | L | 0.19 | 3.3 | OK | Invention Example |
| M-1 | M | 0.44 | 2.5 | OK | Invention Example |
| N-1 | N | 0.48 | 2.6 | OK | Invention Example |
| O-1 | O | 0.22 | 4.1 | OK | Invention Example |
| A-2 | A | 0.62 | 2.3 | NG | Comparative Example |
| B-2 | B | 0.52 | 1.1 | NG | Comparative Example |
| C-2 | C | 0.54 | 2.2 | NG | Comparative Example |
| D-2 | D | 0.65 | 2.4 | NG | Comparative Example |
| E-2 | B | 0.52 | 0.5 | NG | Comparative Example |
| F-2 | F | 0.55 | 5.1 | NG | Comparative Example |
| G-2 | G | 0.55 | 1.1 | NG | Comparative Example |
| H-2 | H | 0.61 | 1.7 | NG | Comparative Example |
| I-2 | I | 0.33 | 0.8 | NG | Comparative Example |
| J-2 | J | 0.61 | 2.5 | NG | Comparative Example |
| K-2 | K | 0.55 | 2.2 | NG | Comparative Example |
| L-2 | L | 0.42 | 0.5 | NG | Comparative Example |
| M-2 | M | 0.21 | 2.4 | NG | Comparative Example |
| N-2 | N | 0.58 | 2.1 | NG | Comparative Example |
| O-2 | O | 0.33 | 5.6 | NG | Comparative Example |
| A-3 | A | 0.54 | 2.3 | NG | Comparative Example |
| B-3 | B | 0.22 | 4.8 | NG | Comparative Example |
| C-3 | C | 0.10 | 3.1 | NG | Comparative Example |
| D-3 | D | 0.54 | 0.1 | NG | Comparative Example |
| E-3 | E | 0.30 | 2.1 | NG | Comparative Example |
| F-3 | F | 0.66 | 0.1 | NG | Comparative Example |

As can be seen from Tables 3A to 3D, 4A, and 4B, in all of the examples according to the present invention, it was possible to obtain a steel sheet having a high strength and excellent hydrogen embrittlement resistance properties particularly by appropriately controlling the conditions of hot rolling, coiling, annealing, and post-annealing cooling.

In A-2, since the hot rolling start temperature was high, the austenite grain diameter coarsened. As a result, the maximum diameter of the granular cementites on the block boundaries and the colony boundaries increased, and the hydrogen embrittlement resistance properties deteriorated.

In B-2, since the finish temperature (hot rolling finishing temperature) was high, the austenite grain diameter coarsened. As a result, the maximum diameter of the granular cementites on the block boundaries and the colony boundaries increased, and the hydrogen embrittlement resistance properties deteriorated.

In C-2, the number of large reduction passes with a rolling reduction of 20% or more was small. As a result, the maximum diameter of the granular cementites on the block boundaries and the colony boundaries increased, and the hydrogen embrittlement resistance properties deteriorated.

In D-2, since the interpass time was long, ferritic transformation excessively occurred. As a result, the maximum diameter of the granular cementites on the block boundaries and the colony boundaries increased, and the hydrogen embrittlement resistance properties deteriorated.

In E-2, since the time between the completion of the hot rolling and the start of the cooling was long, ferritic transformation excessively occurred. As a result, the maximum diameter of the granular cementites on the block boundaries and the colony boundaries increased, and the hydrogen embrittlement resistance properties deteriorated.

In F-2, since the cooling rate after the completion of the hot rolling was low, ferritic transformation excessively occurred and the cementite excessively coarsened. As a result, the cementite remained undissolved in the annealing step, and the tensile strength did not reach 1,200 MPa. In addition, the number density of grains of the granular cementites on the block boundaries and the colony boundaries decreased, and the hydrogen embrittlement resistance properties deteriorated.

In G-2, since the cooling rate after the completion of the hot rolling was high, the cementite after the hot rolling step became small. The austenite coarsened at the annealing temperature, and the pearlite coarsened. Therefore, the maximum diameter of the granular cementites on the block boundaries and the colony boundaries increased, and the hydrogen embrittlement resistance properties deteriorated.

In H-2, since the coiling temperature was low, the size of the cementite after the hot rolling step decreased. As a result, the maximum diameter of the granular cementites on the block boundaries and the colony boundaries increased, and the hydrogen embrittlement resistance properties deteriorated.

In I-2, since the coiling temperature was high, the cementite after the hot rolling step became excessively large. As a result, the area ratio of pearlite decreased, and the hydrogen embrittlement resistance properties deteriorated.

In J-2, since the rate of temperature increase to 700° C. was low, the cementite coarsened. Therefore, the maximum diameter of the granular cementites on the block boundaries and the colony boundaries increased in the pearlite structure after annealing, and the hydrogen embrittlement resistance properties deteriorated.

In K-2, since the rate of temperature increase from 700° C. was low, the cementite coarsened. Therefore, the maximum diameter of the granular cementites on the block boundaries and the colony boundaries increased in the pearlite structure after annealing, and the hydrogen embrittlement resistance properties deteriorated.

In L-2, since the rate of temperature increase from 700° C. was high in the annealing step, the recrystallization of the ferrite was delayed. As a result, the area ratio of pearlite after annealing decreased, and the hydrogen embrittlement resistance properties deteriorated.

In M-2, since the annealing temperature was low, austenitizing does not sufficiently proceed, and the area ratio of the pearlite structure after annealing decreased, Therefore, the hydrogen embrittlement resistance properties deteriorated.

In N-2, since the annealing temperature was high, the austenite coarsened. As a result, the maximum diameter of the granular cementites on the block boundaries and the colony boundaries increased in the pearlite structure, and the hydrogen embrittlement resistance properties deteriorated.

In O-2, the retention time at the highest heating temperature was short in the annealing step. Therefore, since austenitizing does not sufficiently proceed and the proportion of the pearlite structure decreased, the hydrogen embrittlement resistance properties decreased.

In A-3, the retention time at the highest heating temperature was long in the annealing step. Therefore, the austenite coarsened, the maximum diameter of the granular cementites on the block boundaries and the colony boundaries increased in the pearlite structure, and the hydrogen embrittlement resistance properties deteriorated.

In B-3, the cooling rate to the primary cooling temperature was low in the annealing step. Therefore, the area ratio of ferrite was more than 10.0% and the tensile strength was less than 1,200 MPa. In addition, the area ratio of pearlite was less than 90.0%, and as a result, the hydrogen embrittlement resistance properties decreased.

In C-3, since the primary cooling temperature was low in the annealing step, the area ratio of the pearlite structure was less than 90.0%, and as a result, the hydrogen embrittlement resistance properties decreased.

In D-3, since the primary cooling temperature was high in the annealing step, the area ratio of the ferrite structure was more than 10.0%, and the tensile strength did not reach 1,200 MPa. In addition, the cementite coarsened, and as a result, the hydrogen embrittlement resistance properties decreased.

In E-3, since the retention time at the primary cooling temperature was short in the annealing step, the area ratio of the remainder in microstructure was more than 10.0%, and as a result, the hydrogen embrittlement resistance properties deteriorated.

In F-3, since the cooling rate from the primary cooling temperature was low in the annealing step, the cementite coarsened, and as a result, the hydrogen embrittlement resistance properties decreased.

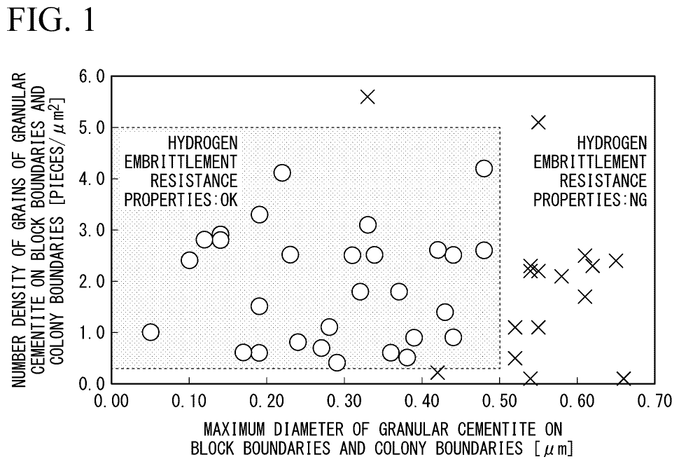

FIG. 1 is a graph showing the influences of the maximum diameter of the granular cementites on the block boundaries and the colony boundaries and the number density of grains of the granular cementites on the block boundaries and the colony boundaries on the hydrogen embrittlement resistance properties of the steel sheets of Example 1 and Example 2. In the drawing, the symbol O (white circle) represents a steel sheet having excellent hydrogen embrittlement resistance properties, and the symbol X represents an example in which the hydrogen embrittlement resistance properties are inferior. As is clear from FIG. 1, it is found that in a case where the maximum diameter of the granular cementites on the block boundaries and the colony boundaries is controlled to 0.50 μm or less, and the number (the number density on the boundaries) of grains of the granular cementites present on the block boundaries and grains of the granular cementites present on the colony boundaries per unit length on the block boundaries and the colony boundaries is controlled to 0.3 pieces/μm or more and 5.0 pieces/μm or less, it is possible to obtain a steel sheet having excellent hydrogen embrittlement resistance properties.

### INDUSTRIAL APPLICABILITY

According to the present invention, it is possible to provide a high strength steel sheet having excellent hydrogen embrittlement resistance properties. This steel sheet contributes to the weight reduction of vehicles' bodies.

1. A steel sheet comprising, as a chemical composition, by mass %:
C: 0.150% or more and less than 0.400%;
Si: 0.01% to 2.00%;
Mn: 0.80% to 2.00%;
P: 0.0001% to 0.0200%;
S: 0.0001% to 0.0200%;
Al: 0.001% to 1.000%;
N: 0.0001% to 0.0200%;
O: 0.0001% to 0.0200%;
Cr: 0.500% to 4.000%;
Co: 0% to 0.500%;
Ni: 0% to 1.000%;
Mo: 0% to 1.0000%;
Ti: 0% to 0.500%;
B: 0% to 0.010%;
Nb: 0% to 0.500%;
V: 0% to 0.500%;
Cu: 0% to 0.500%;
W: 0% to 0.100%;
Ta: 0% to 0.100%;
Sn: 0% to 0.050%;
Sb: 0% to 0.050%;
As: 0% to 0.050%;
Mg: 0% to 0.0500%;
Ca: 0% to 0.050%;
Y: 0% to 0.050%;
Zr: 0% to 0.050%;
La: 0% to 0.050%;
Ce: 0% to 0.050%, and
a remainder: Fe and impurities,
wherein a microstructure at a t/4 portion ranging from ⅛ to ⅜ of a sheet thickness in a sheet thickness direction from a surface includes, by area ratio,
ferrite: less than 10.0%, and
pearlite: more than 90.0%,
a remainder of the microstructure is one or more of bainite, martensite, and residual austenite,
when, in the microstructure, a boundary between a block and an adjacent block included in the pearlite is referred to as a block boundary and a boundary between a colony and an adjacent colony included in the pearlite is referred to as a colony boundary,
granular cementites are present on one or both of the block boundaries and the colony boundaries,
the granular cementites present on the block boundaries and the granular cementites present on the colony boundaries have a maximum diameter of 0.50 μm or less,
the number of grains of the granular cementites present on the block boundaries and grains of the granular cementites present on the colony boundaries per unit length on the block boundaries or the colony boundaries is 0.3 pieces/μm or more and 5.0 pieces/μm or less, and
the granular cementites are cementites having an aspect ratio of less than 10, and a tensile strength is 1,200 MPa or more.

2. The steel sheet according to claim 1,
wherein the chemical composition contains, by mass %, one or more of:
Co: 0.001% to 0.500%,
Ni: 0.001% to 1.000%,
Mo: 0.0005% to 1.0000%,
Ti: 0.001% to 0.500%,
B: 0.001% to 0.010%,
Nb: 0.001% to 0.500%,
V: 0.001% to 0.500%,
Cu: 0.001% to 0.500%,
W: 0.001% to 0.100%,
Ta: 0.001% to 0.100%,
Sn: 0.001% to 0.050%,
Sb: 0.001% to 0.050%,
As: 0.001% to 0.050%,
Mg: 0.0001% to 0.0500%,
Ca: 0.001% to 0.050%,
Y: 0.001% to 0.050%,
Zr: 0.001% to 0.050%,
La: 0.001% to 0.050%, and
Ce: 0.001% to 0.050%.

3. The steel sheet according to claim 1,
wherein a coating layer containing zinc, aluminum, magnesium, or an alloy of these metals is provided on the surface.

4. The steel sheet according to claim 2,
wherein a coating layer containing zinc, aluminum, magnesium, or an alloy of these metals is provided on the surface.
